(19) United States
(12) Patent Application Publication
(10) Pub. No.: US 2026/0189658 A1
(43) Pub. Date: Jul. 2, 2026

(54) METHODS FOR DETERMINING AGENT CAPACITY FOR MANAGING CONTACT CHAT INTERACTIONS

(71) Applicants: AFINITI, LTD, Hamilton (BM); AFINITI, INC., WASHINGTON, DC (US)

(72) Inventors: Eyal Brami, New York, NY (US); Aleshandra Sinha, London (GB); Martin McEnroe, Plano, TX (US); Alessio Tamburro, Wilmington (DE); Felix Xavier Soliman Marie Dujol, London (GB); James Murtaugh, Homdel, NJ (US)

(21) Appl. No.: 19/104,443

(22) PCT Filed: Aug. 24, 2023
(86) PCT No.: PCT/US23/31021

§ 371 Date: Feb. 18, 2025

Related U.S. Application Data
(60) Provisional application No. 63/400,954, filed on Aug. 25, 2022.

(51) Int. Cl. H04M 3/523; H04M 3/51

(52) U.S. Cl. CPC H04M 3/5238; H04M 3/5191

(57) ABSTRACT

Systems and methods are disclosed for determining agent capacity for managing contact interactions. An example method includes obtaining first information of a contact, and active agent device information comprising at least a first agent identifier and a second agent identifier. The example method further includes determining a first capacity of the first agent identifier based on active interactions and dormant interactions associated with the first agent identifier. The example method further includes determining a second capacity of the second agent identifier based on active interactions and dormant interactions associated with the second agent identifier. The example method further includes determining a conversation pattern of the contact, and initiating a comparison of the first capacity and the second capacity based on the conversation pattern. The example method further includes assigning the contact to either of the first agent identifier and the second agent identifier based on the comparison.

### CROSS-REFERENCE TO RELATED APPLICATION

This international patent application claims priority to U.S. Provisional Application No. 63/400,954, filed Aug. 25, 2022, which is hereby incorporated by reference in its entirety as if fully set forth herein.

### FIELD OF THE DISCLOSURE

The present disclosure generally relates to systems and methods within contact centers, and more particularly, to systems and methods within contact centers for determining agent capacity for managing contact text-based interactions (e.g., synchronous and asynchronous chat, messaging, email, and/or other such text-based interactions).

### BACKGROUND OF THE DISCLOSURE

A typical contact center algorithmically assigns contacts arriving at the contact center to agents available to handle those contacts. At times, the contact center may have agents available and waiting for assignment to inbound or outbound contacts (e.g., telephone calls, Internet chat sessions, email, messaging interactions, and the like). At other times, the contact center may have contacts waiting in one or more queues for an agent to become available for assignment.

In some typical contact centers, contacts are assigned to agents ordered based on time of arrival and a longest idle time for the agents. In such implementations, agents receive contacts ordered based on the time when those agents became available. This strategy may be referred to as a “first-in, first-out”, “FIFO”, or “round-robin” strategy. Typically, contacts and/or agents are assigned into different “skill groups” or “queues” prior to applying a FIFO assignment strategy within each such skill group or queue.

Moreover, some contact centers may use a “performance based routing” or “PBR” algorithm or approach to ordering the queue of available agents or, occasionally, contacts. For example, when a contact arrives at a contact center with a plurality of available agents, the ordering of agents available for assignment to that contact would be headed by the highest-performing available agent. PBR ordering strategies attempt to maximize the expected outcome of each contact-agent interaction but do so typically without regard for utilizing agents in a contact center uniformly.

Agent capacity management and optimization issues are compounded based on the channel types managed by the agents. Namely, when the contact center agents are tasked to work on asynchronous channels (e.g., WhatsApp Business, Facebook Messenger, Apple Messages for Business, etc.), capacity management for these agents is significantly different and more complex than capacity management for agents who focus on synchronous channels (e.g., voice, live chat, etc.).

For example, response patterns and customer expectations in synchronous channels are relatively straightforward and simple to manage. In a voice channel, an agent is able to readily and easily converse with one person at a time due to the fact that talking on the phone requires a very close level of attention and a high response frequency from the agent.

By contrast, response patterns and customer expectations in asynchronous channels are vastly different and more complicated to manage than synchronous channels. Users of different messaging technologies (e.g., Apple iMessage, SMS, WhatsApp, Facebook Messenger, Instagram DM, etc.) typically encounter a conversation experience in which they do not expect, and are not expected to, respond immediately or even within a few minutes. Such expectations may be based on modern day messaging technologies in which customers typically communicate via personal devices.

Accordingly, there is a need for methods within contact centers for determining agent capacity for managing contact messaging interactions.

### SUMMARY OF THE DISCLOSURE

The present disclosure generally relates to methods implemented for contact centers. In particular, systems and methods are disclosed for determining agent capacity for managing contact messaging interactions, particularly when such contact messaging interactions take place over asynchronous communication channels. The present disclosure describes techniques for obtaining an available contact, and assigning the contact to an agent that is likely to have sufficient capacity to quickly respond to the contact at the time of the contact's response. These techniques may enable a contact to interact with a single agent by actively tracking and updating the agent's capacity, but in the event that an agent's capacity exceeds a capacity threshold, the systems and methods of the present disclosure may automatically determine a new agent for the contact that is predicted to provide an optimal outcome for the contact's messaging interaction.

As an example, a first agent working as part of a contact center may be allowed to handle a maximum of 3 concurrent asynchronous conversations. Using conventional systems, the first agent may receive 3 conversations from the contact center queue, and the first agent may correspond with the three contacts (e.g., provides a solution to each contact's question, ask each contact for additional information so the agent can investigate further). Following the first agent's correspondence, the first agent may wait to read the contacts'responses to know whether the interactions can be disposed (e.g., terminated, etc.) or if further explanation is needed, but the contacts may not have any interest in responding to the first agent because their expectation is that they can respond to the first agent on their own time. Accordingly, the contacts may read the first agent's message(s) and not respond, or may ignore the notification with the intent to read and respond to it later, or possibly not at all. Such activity, at least in part, may define dormant activity. In this example, the first agent is technically operating at full capacity (e.g., 3 out of 3 allowable conversation slots filled) because conventional systems use a static determination criteria based on the number of conversations assigned compared to the number of allowable concurrent conversations. However, in practice, the first agent may not be actually engaged (e.g., reading, writing, investigating, checking internal systems, etc.) with any of the 3 conversations, and is simply waiting for the contacts to respond. Concurrently, other contacts' inquiries may be filling up the contact center queue, but the conventional system will not assign these inquiries to the first agent because the first agent is technically at full capacity based on the traditional static capacity determination.

By contrast, the systems and methods of the present disclosure overcome these and other issues of conventional techniques by determining a dynamic capacity contact center model, obtaining contact center environment data including an available contact, and assigning the contact to an agent based on the dynamic contact center model and the contact center environment data, as further discussed herein. Generally speaking, the systems and methods of the present disclosure may utilize various contact information of a contact to determine a conversation pattern of the contact. The systems and methods of the present disclosure may also determine capacities of multiple agents based on the number of active and/or dormant interactions currently handled by each agent.

As referenced herein, an “active” interaction may generally indicate an interaction in which the most recent response provided by the contact was submitted within an interaction period threshold (e.g., 5 minutes, 30 minutes, 1 hour, etc.), and a “dormant” interaction may generally indicate an interaction in which the most recent response provided by the contact was not submitted within the interaction period threshold. Additionally, or alternatively, “active” and/or “dormant” conversation(s) determinations may be made based on other/additional factors related to the messaging interaction, such as a time zone in which the contact is based, and/or a pattern of the contact. For example, a relatively inactive messaging interaction with a contact in a time zone where it is currently 2 AM may qualify as a “dormant” messaging interaction. In any event, the systems and methods of the present disclosure may then compare the capacities of respective agents based on the conversation pattern of the contact in order to assign the contact to the respective agent that may best handle the messaging interaction with the contact.

To illustrate, and in reference to the prior example, the systems and methods of the present disclosure may receive an incoming messaging interaction from a contact that includes contact information about the contact. In one embodiment, the systems and methods of the present disclosure may also analyze the first agent's capacity and determine that the first agent discussed above currently has 3 dormant interactions because none of the contacts included as part of the 3 messaging interactions currently handled by the first agent have responded to the first agent within the past hour (or other suitable duration). Accordingly, the systems and methods of the present disclosure may analyze the first agent's capacity (along with the capacity of other agents) in relation to the contact information, and determine that the contact should be assigned to the first agent because the first agent is operating at a minimal capacity/low utilization.

Additionally, in certain instances, the systems and methods of the present disclosure may utilize both a pre-determined agent capacity model and/or reinforcement learning models/techniques to determine contact patterns and/or agent capacities in order to determine the optimal contact-agent assignments. In particular, when the methods of the present disclosure determine such contact patterns and agent capacities, the systems and methods of the present disclosure may: utilize the pre-determined model to assign additional work items to an agent during idle times (e.g., when the agent is not engaged in responding to a contact), automatically switch focus to either bot or human agent utterances in the same conversation based on predictions of conversation cost and outcome gain, automatically switch the conversation to a different agent, automatically assign a multiple topic conversation to agents of specific top skill (e.g., billing resolution, plan change, equipment sale, etc.), allow the agents to view the queue and select conversations in order to acquire rewards on metrics devised by a client, allow the agents to support mixed-channel interactions where an idle agent can select a conversation from the queue and progress it while waiting for the next contact pairing, utilize the pre-determined model to assign additional work items to an agent during busy times when the agent is already engaged in a conversation.

Benefits arise from managing agent capacities in a dynamic manner, as described herein. For example, a contact center, and its underlying systems, operations, and/or other aspects of the contact center in general, may experience a performance increase from implementation of such dynamic agent capacity management. Such performance increases may stem from reductions in the number of contacts in queue at the contact center, reduced numbers of agents in queue at the contact center, or otherwise more efficient handling of the overall channel interaction load on the contact center at any given time. More specifically, the systems and methods of the present disclosure dramatically improve agent allocation efficiency (e.g., a balanced agent utilization among the agents of a contact center system) and outcomes in synchronous channel and asynchronous channel applications relative to conventional techniques. As a result, the systems and methods of the present disclosure enable agents to have significantly higher utilizations than conventional systems, such that the agents may achieve more conversations and other work items handled per hour and ultimately increase the profitability and cost saving of the contact center. Other differences in performance may also include a number of transactions completed over a certain period of time, increase in transactions (e.g., sales) amount, or percentage sales increase, or the like.

In accordance with various aspects herein, a method is disclosed for determining agent capacity for managing contact messaging interactions. The method may comprise obtaining, by a communications server, first information of a contact. The method may further comprise obtaining, by the communications server, active agent device information comprising at least a first agent identifier and a second agent identifier. The method may further comprise determining a first capacity of the first agent identifier based on a number of active interactions associated with the first agent identifier and a number of dormant interactions associated with the first agent identifier. The method may further comprise determining a second capacity of the second agent identifier based on a number of active interactions associated with the second agent identifier and a number of dormant interactions associated with the second agent identifier. The method may further comprise determining a conversation pattern of the contact based on the first information. The method may further comprise initiating a comparison of the first capacity and the second capacity based on the conversation pattern. The method may further comprise assigning the contact to either of the first agent identifier and the second agent identifier based on the comparison, wherein assigning the contact comprises establishing a connection between a first device associated with the contact and a second device associated with the first agent identifier or the second agent identifier.

In still further aspects, the methods may comprise establishing a communication channel across the connection; obtaining a first message at the second device transmitted by the first device; and obtaining a second message at the first device transmitted by the second device. Further in these aspects, the methods may comprise, after obtaining the first message at the second device transmitted by the first device, obtaining second information of the contact; and determining an updated capacity of the agent identifier associated with the second device based on the second information of the contact. Still further in these aspects, the methods may comprise, after obtaining the first message at the second device transmitted by the first device, determining an expected wait time for obtaining a third message at the second device transmitted by the first device, wherein the expected wait time is based on the first message; and determining an updated capacity of the agent identifier associated with the second device based on the expected wait time.

In yet further aspects, the methods may comprise obtaining historical contact-agent interaction data; and determining the conversation pattern of the contact based on the historical contact-agent interaction data. Further in these aspects, the historical contact-agent interaction data may be associated with the contact. Still further in these aspects, the historical contact-agent interaction data may be based on information from at least one other contact, the at least one other contact being different from the contact.

In still further aspects, the methods may comprise determining an interaction handle time for the contact.

In yet further aspects, the methods may comprise determining a response rate variability for the contact.

In still further aspects, the methods may comprise training a machine-learning model based on a training dataset comprising historical contact-agent interaction data, wherein the machine-learning model is configured to output a prediction of an expected capacity of an agent.

In yet further aspects, the methods may comprise determining a response lag time measurement based on historical contact-agent interaction data associated with a contact type of the contact.

In still further aspects, the first information may comprise at least one of a message text and one or more tags or headers associated with the message text.

In yet further aspects, the contact may be communicatively coupled to a contact center and the contact may transmit one or more messages to a third device associated with a third agent identifier.

In still further aspects, a method for allocating contacts to agents is disclosed. The method may comprise: obtaining contact center environment data associated with a contact center system; training a reinforcement learning model based on a training dataset comprising historical contact-agent interaction data associated with the contact center system; obtaining a first state of the contact center system, the first state comprising (i) a utilization value and/or pattern of each agent of a plurality of agents, and (ii) an indication of at least one available contact; assigning, based on using the first state as input to the trained reinforcement learning model, the at least one available contact to a first agent of the plurality of agents; and outputting a second state of the contact center system based on assigning the at least one available contact to the first agent.

In yet further aspects, training the reinforcement learning model further comprises: determining a time period associated with an average agent response time per single contact-interaction, and wherein the training dataset further comprises the time period. Further in these aspects, the time period is one of: 15 seconds, 30 seconds, 45 seconds, 1 minute, and 2 minutes.

In still further aspects, training the reinforcement learning model further comprises: determining at least one positive reward based on at least one of: an agent utilization value and a length of agent utilization, and wherein the training dataset further comprises the at least one positive reward. Further in these aspects, the at least one positive reward comprises (i) an allocation reward based on a number of utilized time slots for a respective agent, and (ii) a time difference between a first time value that a respective agent is available and a second time value that the respective agent handled a final interaction. Still further in these aspects, the at least one positive reward comprises a total agent reward, comprising a sum of the allocation rewards for each respective agent of the plurality of agents.

In yet further aspects, training the reinforcement learning model further comprises: determining at least one negative reward based on at least one of: an agent wait time and a contact wait time, and wherein the training dataset further comprises the at least one negative reward.

In still further aspects, the method further comprises: determining a contact arrival event or an agent state change event, and wherein obtaining the first state of the contact center system occurs after the determining the contact arrival event or the agent state change event.

In yet further aspects, the contact center environment data comprises any of: (i) a number of active conversations associated with one or more agents of the plurality of agents at the contact center system, (ii) a number of dormant conversations associated with one or more agents of the plurality of agents at the contact center system, (iii) a pattern associated with one or more contacts of a plurality of contacts handled by the contact center system, and (iv) a message text associated with one or more contacts of a plurality of contacts handled by the contact center system.

In additional aspects, a communications system for determining agent capacity for managing contact messaging interactions is disclosed. The communications system may comprise one or more processors, and a non-transitory computer-readable medium coupled to the one or more processors. The non-transitory computer-readable medium may store instructions thereon that, when executed by the one or more processors, cause the communications system to obtain first information of a contact. The non-transitory computer-readable medium may store instructions thereon that, when executed by the one or more processors, further cause the communications system to obtain active agent device information comprising at least a first agent identifier and a second agent identifier. The non-transitory computer-readable medium may store instructions thereon that, when executed by the one or more processors, further cause the communications system to determine a first capacity of the first agent identifier based on a number of active interactions associated with the first agent identifier and a number of dormant interactions associated with the first agent identifier. The non-transitory computer-readable medium may store instructions thereon that, when executed by the one or more processors, further cause the communications system to determine a second capacity of the second agent identifier based on a number of active interactions associated with the second agent identifier and a number of dormant interactions associated with the second agent identifier. The non-transitory computer-readable medium may store instructions thereon that, when executed by the one or more processors, further cause the communications system to determine a conversation pattern of the contact based on the first information. The non-transitory computer-readable medium may store instructions thereon that, when executed by the one or more processors, further cause the communications system to initiate a comparison of the first capacity and the second capacity based on the conversation pattern. The non-transitory computer-readable medium may store instructions thereon that, when executed by the one or more processors, further cause the communications system to assign the contact to either of the first agent identifier and the second agent identifier based on the comparison, wherein assigning the contact establishes a connection between a first device associated with the contact and a second device associated with the first agent identifier or the second agent identifier.

In still further aspects, a tangible, non-transitory computer-readable medium storing computing instructions for determining agent capacity for managing contact messaging interactions is disclosed. The computing instructions when executed by one or more processors may cause the one or more processors to obtain first information of a contact. The computing instructions when executed by one or more processors may further cause the one or more processors to obtain active agent device information comprising at least a first agent identifier and a second agent identifier. The computing instructions when executed by one or more processors may further cause the one or more processors to determine a first capacity of the first agent identifier based on a number of active interactions associated with the first agent identifier and a number of dormant interactions associated with the first agent identifier. The computing instructions when executed by one or more processors may further cause the one or more processors to determine a second capacity of the second agent identifier based on a number of active interactions associated with the second agent identifier and a number of dormant interactions associated with the second agent identifier. The computing instructions when executed by one or more processors may further cause the one or more processors to determine a conversation pattern of the contact based on the first information. The computing instructions when executed by one or more processors may further cause the one or more processors to compare the first capacity and the second capacity based on the conversation pattern. The computing instructions when executed by one or more processors may further cause the one or more processors to assign the contact to either of the first agent identifier and the second agent identifier based on the comparison, wherein assigning the contact establishes a connection between a first device associated with the contact and a second device associated with the first agent identifier or the second agent identifier.

In accordance with the above, and with the disclosure herein, the present disclosure includes improvements in underlying computer functionality or in improvements to other technologies at least because the present disclosure includes, e.g., dynamically determining agent capacities and/or contact conversation patterns related to messaging interactions in contact centers for improvement thereof. Such agent capacities and contact conversation patterns may correspond to telecommunication connections or computing resources (e.g., memory and/or processor resources) of a contact center system comprising computing systems in the field of contact center routing, distribution, and/or management. That is, the present disclosure describes improvements in the functioning of an underlying computing system itself or “any other technology or technical field” because a contact center, and its underlying contact/interaction processing hardware and devices, are improved by allowing the contact center, and related resources, such as telecommunications connections allocated in the contact center system (e.g., telecommunications connections between an agent and a contact) to be routed or established based on algorithms utilizing these agent capacities and contact conversation patterns. This provides an improvement over prior systems that do not implement such determinations of agent capacities and contact conversation patterns, as described herein. For example, such implementation improves over the prior art at least because a contact center, as improved based on insights from the agent capacities and contact conversation patterns as described herein, allow the systems and methods of the contact center to operate with limited or reduced resources (e.g., limited or fewer telecommunication connections and/or limited or reduced processing or memory utilization of a contact processing system) or experience increased performance (e.g., higher contact messaging interaction throughput, higher agent utilization, and/or more balanced agent utilization) compared with non-optimizing systems. Namely, pairing an agent of the contact center to a contact comprises establishing a telecommunication or other connection to provide voice, text, or other communication(s) between the agent and the contact. Such pairing may require not only telephonic connections, but may also require processor, memory, and networking connection and/or bandwidth of the contact center. The agent capacities and contact conversation patterns described herein may be used to more efficiently assign agents to contacts, which in turn, directly improves the allocation efficiency of such resources.

Additionally or alternatively, the present disclosure relates to improvements to other technologies or technical fields at least because information of a contact may be used to determine a conversation pattern for the contact, and multiple agent capacities may be determined by considering both active and dormant interactions handled by the agents. In such aspects, the conversation pattern of the contact may be used as a basis of comparison for multiple agent capacities to determine an optimal agent to handle the contact's messaging interaction. In this manner, both the conversation pattern of the contact and the agent capacities are used improve the performance of one or more features of the contact center system, for example, by assigning a contact to an agent based on such conversation patterns and agent capacities, and thereby providing an improvement in terms of increased agent utilization, increased balance of agent utilization, increased messaging interaction throughput, reduced telecommunication connection usage, reduced memory usage, reduced processing usage, reduced handle time, and/or increased performance of transactions and/or sales, improved customer experience/service, or other benefits to the contact center as described herein.

In addition, the present disclosure includes the application of or use of a particular machine, e.g., a messaging feature server (also referenced herein as a “communications server”) as deployed in a contact center, where the messaging feature server may be configured to determine conversation patterns of contacts and agent capacities of agents and assign contacts to agents accordingly, in accordance with the systems and methods for determining agent capacity for managing contact messaging interactions, as described herein.

Still further, the present disclosure includes specific features other than what is well-understood, routine, conventional activity in the field, because such features add unconventional steps that confine the disclosure to a particular useful application, e.g., systems and methods within contact centers for determining agent capacity for managing contact messaging interactions by determining conversation patterns of contacts and agent capacities of agents, and assigning contacts to agents based on the conversation patterns and agent capacities.

Advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

The present disclosure will now be described in more detail with reference to particular aspects thereof as shown in the accompanying drawings. While the present disclosure is described below with reference to particular aspects, it should be understood that the present disclosure is not limited thereto. Those of ordinary skill in the art having access to the teachings herein will recognize additional implementations, modifications, and aspects, as well as other fields of use, which are within the scope of the present disclosure as described herein, and with respect to which the present disclosure may be of significant utility.

### BRIEF DESCRIPTION OF THE DRAWINGS

To facilitate a fuller understanding of the present disclosure, reference is now made to the accompanying drawings, in which like elements are referenced with like numerals. These drawings should not be construed as limiting the present disclosure, but are intended to be illustrative only.

FIG. 1A depicts a block diagram of an example contact center system, in accordance with various aspects of the present disclosure.

FIG. 1B depicts a block diagram of a second example contact center system, in accordance with various aspects of the present disclosure.

FIG. 1C depicts a block diagram of an example communication system that includes an example configuration of a contact center as a service (CCaaS), in accordance with various aspects of the present disclosure.

FIG. 1D depicts a block diagram of a multi-tenancy embodiment of the example contact center system of FIG. 1B, in accordance with various aspects of the present disclosure.

FIG. 2 depicts a block diagram of another example contact center system utilizing the messaging feature server of FIG. 1, in accordance with various aspects of the present disclosure.

FIG. 3 depicts a block diagram of an agent capacity prediction implementation of the messaging feature server of FIG. 1, in accordance with aspects of the present disclosure.

FIG. 4 illustrates an example interaction sequence between an agent and several contacts where the wait time experienced by the agent and contacts may be identified and minimized by the techniques of the present disclosure, in accordance with aspects of the present disclosure.

FIG. 5 illustrates another example interaction sequence between multiple agents and multiple contacts where the wait time experienced by each agent and each contact may be identified and minimized by the techniques of the present disclosure, and in accordance with aspects of the present disclosure.

FIG. 6 illustrates yet another example interaction sequence between two agents each simultaneously handling multiple contacts where the wait time experienced by each agent and each contact may be identified and minimized by the techniques of the present disclosure, in accordance with aspects of the present disclosure.

FIG. 7 illustrates an example optimized interaction sequence between the two agents and the multiple contacts of FIG. 6, in accordance with aspects of the present disclosure.

FIG. 8 illustrates a method for determining agent capacity for managing contact messaging interactions, in accordance with various aspects of the present disclosure.

FIG. 9 illustrates a method for allocating contacts to agents, in accordance with various aspects of the present disclosure.

### DETAILED DESCRIPTION

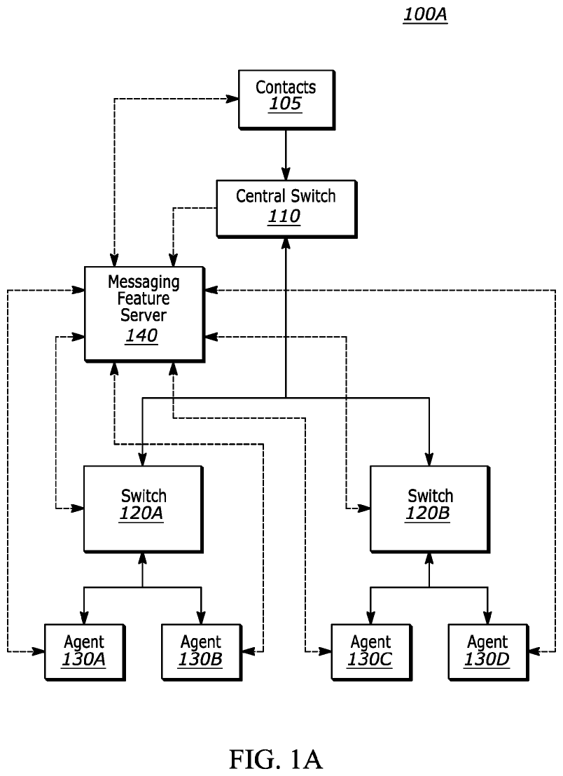

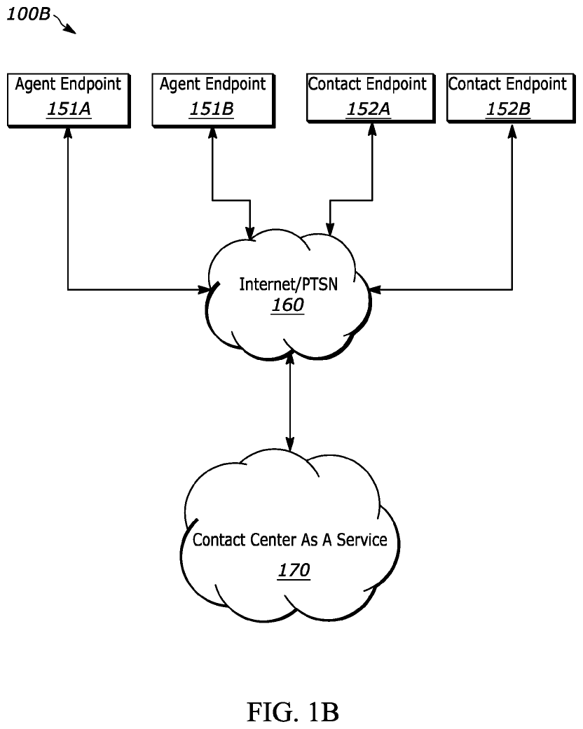

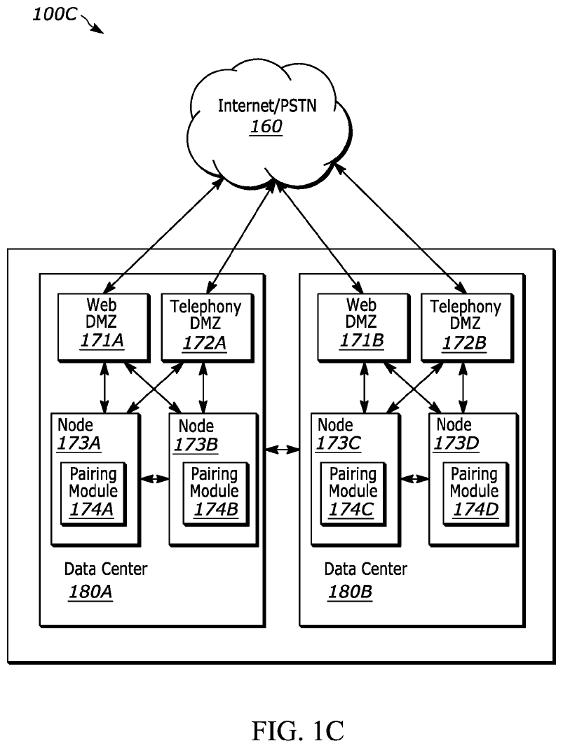

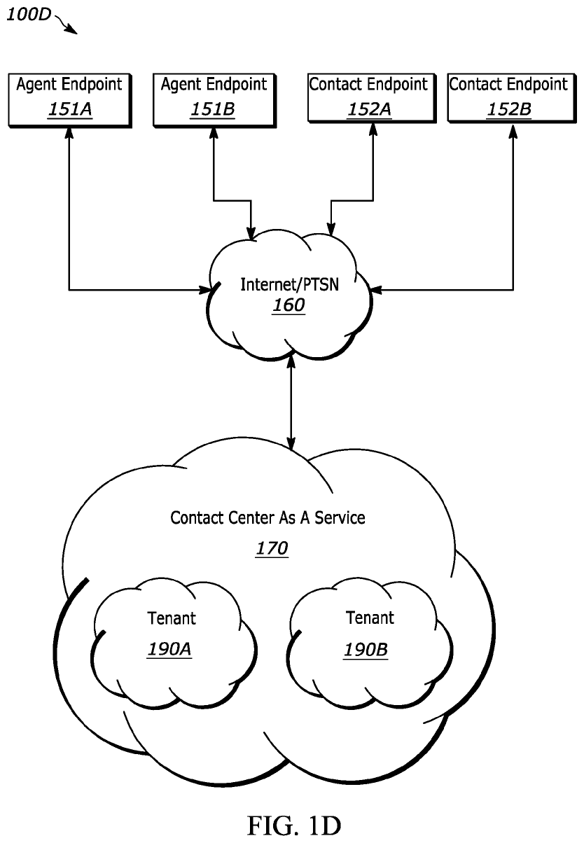

FIG. 1A depicts a block diagram of an example contact center system 100A, in accordance with various aspects of the present disclosure. As illustrated by the example contact center system 100A of FIG. 1A, the systems and methods herein comprise network elements, computers, and/or computing instructions for determining agent capacity for managing contact messaging interactions that may include one or more modules. As used herein, the term “module” may be understood to refer to computing software, instructions, firmware, hardware, and/or various combinations thereof. Modules, however, are not to be interpreted as software which is not implemented on hardware, firmware, or recorded on a processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

Moreover, while the interactions described with reference to FIG. 1A primarily describe contacts calling into the example contact center system 100A, it should be understood that the example contact center system 100A may support any suitable messaging interactions, and indeed any suitable interactions across any type of platform (e.g., video, etc.). For example, the “messaging interactions” (or simply “interactions”) described herein, may include, without limitation, contacts interacting with agents through text messaging (e.g., Apple iMessage, SMS, WhatsApp, etc.), application messaging (e.g., Facebook Messenger, Instagram Direct Messaging (DM), web messaging), email, voice chatting (e.g., live telephone call), video calls, chatbots, chat interactions, and/or any other suitable communication channel or combinations thereof. Further, in certain instances, the messaging interactions between a single contact and a single agent may include one or more of the communication channels described herein, and the contact may be transferred to a different agent to continue the messaging interaction through one or more of the communication channels and/or may simultaneously communicate to multiple agents across the same or different communication channels.

In any event, as shown in FIG. 1A, the example contact center system 100A may include a central switch 110. The central switch 110 may receive incoming contacts 105 (e.g., messaging participants, text participants, callers) or support outbound connections to contacts via a dialer, a telecommunications network, or other modules (not shown). The central switch 110 may include contact routing hardware and software for helping to route contacts among one or more contact center systems, or to one or more Private Branch Exchanges (PBXs) and/or Automated Call Distribution (ACD) systems or other queuing or switching components within a contact center. For example, the PBX and/or ACD may manage, route, or otherwise distribute interactions based on one or more distribution rules, such as the number called, line, timetable, and other parameters, which are configurable to dynamically update or change the operation of the contact center. The rules of the PBX and/or ACD, or more generally the operation of the PBX and/or ACD, may be modified, updated, or otherwise configured by the messaging feature server 140.

In some aspects, the central switch 110 may not be necessary if there is only one contact center, or if there is only one PBX/ACD routing component, in the example contact center system 100A. If more than one contact center is part of the contact center system 100A, each contact center may include at least one contact center switch (e.g., contact center switches 120A and 120B). The contact center switches 120A and 120B may be communicatively coupled to the central switch 110.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-interaction functions such as logging information about the interaction, or taking a break.

In the example of FIG. 1A, the central switch 110 routes contacts to one of two contact centers via contact center switch 120A and contact center switch 120B, respectively. Each of the contact center switches 120A and 120B are shown with two agents each. Agents 130A and 130B may be logged into contact center switch 120A, and agents 130C and 130D may be logged into contact center switch 120B. It is to be understood, however, that additional or fewer agents may be allocated or otherwise associated with a given switch or router within a contact center system. Moreover, as referenced herein, each agent 130A-D may have an associated “agent identifier,” which the contact center system 100A, and more specifically, the messaging feature server 140 may track active and dormant interactions of the agents 130A-D, assign the agents 130A-D additional contacts, and/or perform other suitable actions or combinations thereof with respect to the agents 130A-D.

In various aspects, the contact center system 100A may also be communicatively coupled to a messaging feature server 140. The messaging feature server 140 may comprise a computing system including one or more processors, one or more memories, and related computing instructions for execution of software or instructions as described herein. In some aspects, the messaging feature server 140 may be integrated as part of the contact center system 100A, such as integrated into an existing computing device or server of the contact center. Additionally, or alternatively, the messaging feature server 140 may be a separate computing system (e.g., such as a computing device as provided by a third party) that is connected via a computer network of the contact center. That is, in some aspects, switches of the contact center system 100A may be communicatively coupled to the messaging feature server 140 via a network or otherwise cable connection, and, in some aspects, may include multiple messaging feature servers like the messaging feature server 140. In the example of FIG. 1A, the messaging feature server 140 may be communicatively coupled to one or more switches in the switch system of the contact center system 100A, including the central switch 110, the contact center switch 120A, and the contact center switch 120B. Further, the messaging feature server 140 may be directly communicatively coupled to one or more of the contacts or agents that are included as part of the contact center system 100A, including the contacts 105, the agent 103A, the agent 130B, the agent 130C, and the agent 130D.

The messaging feature server 140 may receive data/information from a PBX/ACD of the contact center system 100A and/or a switch (e.g., contact center switch 120A) of the contact center system 100A about agents logged in to the switch or otherwise contact center system 100A (e.g., agents 130A and 130B) and about incoming contacts. In some aspects, such information may be received via another switch (e.g., central switch 110) or, in some aspects, from a network (e.g., the Internet or a telecommunications network) (not shown). For example, the messaging feature server 140 may receive/obtain data regarding contacts 105, such as a contact arriving or otherwise connecting at a contact center, a contact leaving or otherwise disconnecting from the contact center, or a contact's interactions with the contact center, which may include the contact's pairing by a pairing system, interactions with an agent, selections made (e.g., such as menu selections from a messaging interface, number phone menu, and/or other selection interface causing the contact to be routed or directed in one or more ways within the routing network of the contact center system 100A), or any other event that defines interaction or status of the contact with the contact center. Similarly, as a further example, the messaging feature server 140 may receive/obtain data regarding agents, such as an agent logging into or otherwise connecting at a contact center, an agent logging out or otherwise disconnecting from the contact center, or an agent's interactions with the contact center, which may include the agent's pairing by a pairing system, interactions with a contact, selections made (e.g., such as menu selections from a menu while the agent handles or otherwise interacts with a contact), and/or any other event that defines interaction or status of the agent with the contact center.

The messaging feature server 140 may process this data to determine which contacts 105 should be paired (e.g., matched, assigned, distributed, or otherwise routed within contact center system 100A) with which agents 130A-D. That is, the messaging feature server 140, or more generally contact center system 100A, is configured to algorithmically assign contacts 105 arriving at the contact center to agents 130A-D available to handle those contacts 105, as described further herein. At times, the contact center may be in an “L1 state” as defined by a state where the contact center system 100A has agents 130A-D available and waiting for assignment to inbound or outbound contacts 105 (e.g., text messaging, Internet messaging sessions, email, telephone calls, etc.). At other times, the contact center system 100A may be in an “L2 state” (i.e., an L2 queue) as defined by a state where the contact center system 100A has contacts 105 waiting in one or more queues for an agent 130A-D to become available for assignment. Such L2 queues could be inbound, outbound, or virtual queues. At other times, the contact center system 100A may be in an “L3 state” as defined by a state where the contact center system 100A has contacts 105 waiting in one or more queues for an agent 130A-D to become available for assignment and the contact center system 100A has agents 130A-D available and waiting for assignment to inbound or outbound contacts 105 (e.g., text messaging, Internet messaging sessions, email, telephone calls, etc.).

For example, in one aspect, the messaging feature server 140 may be configured to assign contacts 105 to agents 130A-D when the contact center system 100A is in any suitable state (e.g., L1,L2, or L3 states) by tracking agent messaging interactions to determine the number of active and dormant interactions for each agent 130A-D. For example, in one aspect, multiple agents 130A-D may be available and waiting for connection to a contact 105 (i.e., contact center system 100A is in an L1 state), and a contact 105 arrives at the contact center via a network or central switch. The messaging feature server 140 may automatically analyze the information associated with the contact 105, the capacities of the agents 130A-D, historical contact-agent interaction data, and/or any other suitable data in order to assign the contact 105 to an agent 103A-D.

Generally speaking, the information associated with the contact 105 and/or the historical contact-agent interaction data may include historical/current response time data and/or patterns for the contact 105 and/or contacts that are similar to the contact. For example, the information associated with the contact 105 and/or the historical contact-agent interaction data may include, without limitation, response time data and/or patterns associated with and/or related to any of the following: previous messaging interactions involving the contact 105, a current messaging interaction for the contact 105, contacts that have similar demographic characteristics to the contact 105, the contact 105 or other contacts when participating in a messaging interaction about a specific topic, contacts during the same day when the contact 105 attempts to initiate a messaging interaction with an agent 130A-D, contacts during a similar time (e.g., time of day or specific date/time) when the contact 105 attempts to initiate a messaging interaction with an agent 130A-D, contacts in the specific messaging channel (e.g., text messaging, Internet messaging, email, etc.) in which the contact 105 attempts to initiate a messaging interaction with an agent 130A-D, the contact 105 and/or all contacts in the specific messaging channel after a suitable number of messages, the contact 105 based on a number of previous messaging interactions, the contact 105 based on a number of words used in a sentence, the contact 105 based on sentiment (e.g., via text analysis) of the messaging interaction, the contact 105 based on an urgency of the issue discussed in the messaging interaction, messaging interactions stored in the messaging interaction queue, the contact's 105 main language and the contact's 105 conversation language, the device type of a device utilized by the contact 105 to conduct the messaging interaction, contacts conducting messaging interactions with the same and/or similar device type to the contact 105, messaging interactions with contact typing mistakes.

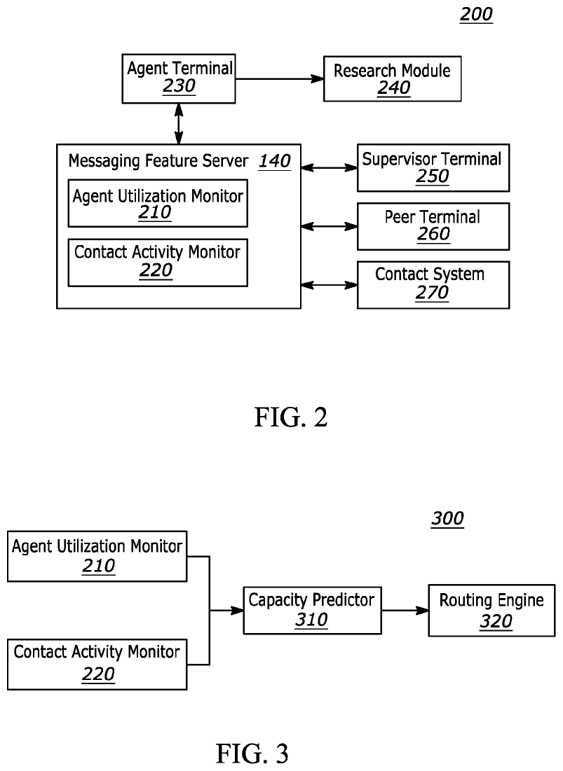

Regardless, in one example, the assigned agent (e.g., agent 130A) may be presented with an option to accept the new contact 105, and upon the agent's 130A acceptance, the agent 130A may be connected to the new contact 105 to begin a messaging interaction. In another example, the agent 130A may be connected to the new contact 105 without waiting for the agent's acceptance. Therefore, the messaging feature server 140 may automatically assign the contact 105 to an agent (e.g., agent 130A) that is predicted to provide an optimal messaging interaction experience for the contact center system 100A, thereby increasing overall contact performance metrics (e.g., bandwidth, throughput, customer satisfaction, revenue, retention, etc.). The algorithms and analyses used to determine such optimal contact-agent pairings are further described with respect to FIGS. 2 and 3.

FIG. 1B depicts a block diagram of a second example contact center system 100AB, in accordance with various aspects of the present disclosure. As shown in FIG. 1B, the communication system 100B may include one or more agent endpoints 151A, 151B and one or more contact endpoints 152A, 152B. The agent endpoints 151A, 151B may include an agent terminal and/or an agent computing device (e.g., laptop, cellphone). The contact endpoints 151A, 151B may include a contact terminal and/or a contact computing device (e.g., laptop, cellphone). Agent endpoints 151A, 151B and/or contact endpoints 152A, 152B may connect to a Contact Center as a Service (CCaaS) 170 through either the Internet or a public switched telephone network (PSTN) 160, according to the capabilities of the endpoint device.

FIG. 1C depicts a block diagram of an example communication system 100C that includes an example configuration of a contact center as a service (CCaaS) 170, in accordance with various aspects of the present disclosure. For example, the CCaaS 170 may include multiple data centers 180A, 180B. The data centers 180A, 180B may be separated physically, even in different countries and/or continents. The data centers 180A, 180B may communicate with each other. For example, one data center is a backup for the other data center; so that, in some embodiments, only one data center 180A or 180B receives agent endpoints 151A, 151B and contact endpoints 152A, 152B at a time.

Each data center 180A, 180B includes web demilitarized zone equipment 171A and 171B, respectively, which is configured to receive the agent endpoints 151A, 151B and contact endpoints 152A, 152B, which are communicatively connecting to CCaaS via the Internet. Web demilitarized zone (DMZ) equipment 171A and 171B may operate outside a firewall to connect with the agent endpoints 151A, 151B and contact endpoints 152A, 152B while the rest of the components of data centers 180A, 180B may be within said firewall (besides the telephony DMZ equipment 172A, 172B, which may also be outside said firewall). Similarly, each data center 180A, 180B includes telephony DMZ equipment 172A and 172B, respectively, which is configured to receive agent endpoints 151A, 151B and contact endpoints 152A, 152B, which are communicatively connecting to CCaaS via the PSTN 160. Telephony DMZ equipment 172A and 172B may operate outside a firewall to connect with the agent endpoints 151A, 151B and contact endpoints 152A, 152B while the rest of the components of data centers 180A, 180B (excluding web DMZ equipment 171A, 171B) may be within said firewall.

Further, each data center 180A, 180B may include one or more nodes 173A, 173B, and 173C, 173D, respectively. All nodes 173A, 173B and 173C, 173D may communicate with web DMZ equipment 171A and 171B, respectively, and with telephony DMZ equipment 172A and 172B, respectively. In some embodiments, only one node in each data center 180A, 180B may be communicating with web DMZ equipment 171A, 171B and with telephony DMZ equipment 172A, 172B at a time.

Each node 173A, 173B, 173C, 173D may have one or more pairing modules 174A, 174B, 174C, 174D, respectively. Similar to the messaging feature server 140 of the contact center system 100A of FIG. 1A, the pairing modules 174A, 174B, 174C, 174D may pair contacts to agents. For example, the pairing modules 174A, 174b, 174C, 174D may alternate between enabling pairing via a Behavioral Pairing (BP) module and enabling pairing with a First-in-First-out (FIFO) module. For example, the pairing modules 174A, 174b, 174C, 174D may be configured to emulate other pairing strategies.

FIG. 1D depicts a block diagram of a multi-tenancy embodiment of the example contact center system of FIG. 1B, in accordance with various aspects of the present disclosure. In particular, the disclosed CCaaS communication systems (e.g., FIGS. 1B and/or 1C) may support multi-tenancy such that multiple contact centers (or contact center operations or businesses) may be operated on a shared environment. That is, multiple tenants, each with their own set of non-overlapping agents, may be handled by the disclosed CCaaS communication systems, where each agent is only interacting with the contacts of a single tenant. CcaaS 170 is shown in FIG. 1D as comprising two tenants 190A and 190B. Turning back to FIG. 1C, for example, multi-tenancy may be supported by node 173A supporting tenant 190A while node 173B supports 190B. In another embodiment, data center 180A supports tenant 190A while data center 180B supports tenant 190B. In another example, multi-tenancy may be supported through a shared machine or shared virtual machine; such that node 173A may support both tenants 190A and 190B, and similarly for nodes 173B, 173C, and 173D. In other embodiments, the system may be configured for a single tenant within a dedicated environment such as a private machine or private virtual machine.

FIG. 2 depicts a block diagram of another example contact center system 200 utilizing the messaging feature server 140 of FIG. 1, in accordance with various aspects of the present disclosure. In particular, the messaging feature server 140 includes an agent utilization monitor 210 and a contact activity monitor 220 that, collectively, are configured to track/determine agent capacity and contact conversation data and/or patterns in order to determine optimal contact-agent pairings for messaging interactions. The example contact center system 200 additionally includes an agent terminal 230, a research module 240, a supervisor terminal 250, a peer terminal 260, and a contact system 270.

Generally speaking, through the messaging feature server 140, an agent (e.g., via agent terminal 230) may establish communication with any other party that is communicatively coupled to the messaging feature server 140, such as the supervisor terminal 250, a peer terminal 260 (e.g., another agent), and/or a contact (e.g., via the contact system 270). The agent terminal 230 may also access the research module 240 to retrieve/obtain information related to the other entity with which the agent is conducting a messaging interaction. For example, if the agent terminal 230 connects to the contact system 270 through the messaging feature server 140 in order to conduct a messaging interaction with a contact, then the agent may access the research module 240 to obtain information about the contact participating in the messaging interaction. The research module 240 may store information related to a contact or another agent, such as, number of prior messaging interactions, length of prior messaging interactions, channel type (e.g., text message, Internet messaging, email, phone call, etc.) of prior messaging interactions, contact demographic information, and/or any other suitable data or combinations thereof. The research module may further store information related to the business entity hosting the messaging interaction (e.g., offers, merchandise, available resources, resource quantities, etc.). Thus, in this manner, an agent may obtain information from the research module 240 about a contact, about a business entity, and/or another agent before, during, or after a messaging interaction.

Moreover, before, during, and/or after such messaging interactions, the agent utilization monitor 210 and contact activity monitor 220 may obtain and/or analyze data related to the agent and the contact to track/determine agent capacity and contact conversation data and/or patterns in order to determine optimal contact-agent pairings for messaging interactions. Namely, the agent utilization monitor 210 may track active messaging interactions and dormant messaging interactions in order to determine an agent's capacity at any given time. The agent utilization monitor 210 may also make decisions related to the determined agent capacity, such as whether or not an agent has sufficient capacity to handle an additional messaging interaction, when the agent will likely have sufficient capacity to handle an additional messaging interaction, what type(s) of messaging interactions the agent may have capacity to handle, and/or which agent of a plurality of agents should optimally handle an additional messaging interaction. Thus, the agent utilization monitor 210 may alleviate messaging interaction queue build-up and maximize agent utilization by dynamically analyzing the capacity of each individual agent. These features of the agent utilization monitor 210 improve over conventional contact centers, at least in that such conventional contact centers are simply incapable of providing this dynamic agent capacity analysis.

To illustrate, conventional contact centers typically include static caps for active and dormant messaging interactions that strictly limit agents to, for example, 3 active messaging interactions and 5 dormant messaging interactions (e.g., a predetermined active threshold and a predetermined dormant threshold). Thus, in these conventional contact centers, agents with 3 active messaging interactions are unable to receive any new messaging interaction assignments unless one or more of their active messaging interactions transitions to a dormant interaction, and the agent's total number of dormant conversations is less than the predetermined dormant threshold. However, if the agent already has 5 dormant interactions, then the agent might be incapable of receiving any new interaction assignments.

This sort of static determinations of active and dormant thresholds fails to suitably reflect the complex nature of interactions between a contact and agent, and further fails to adapt when conversations do not fit into a binary categorization of ‘active’ or ‘dormant.’ For example, during a text message interaction, contacts may initially respond within seconds or minutes of messages from an agent, but contacts generally prefer to text at their convenience (e.g., after consulting with others, etc.) and may lengthen the timeframe over which the interaction takes place by responding at a later time. These text messaging interactions, and other increasingly common interaction methods, create a more sophisticated interaction landscape with significantly longer-term interactions than conventional contact centers are equipped to handle. Conventional contact center may simply disconnect a contact after the contact does not respond for a threshold period of time (e.g., five minutes). As a result, these longer-form interactions pose a significant problem for conventional contact centers applying a static threshold model for managing agent capacity because the agents have pre-defined interaction quotas that do not allow for flexibility in the assignment of interactions. In addition, as a result of different expectations and use patterns of async messaging channels, a contact may decide to take a long time (minutes, hours, days, or more) to response to an agent message, which creates a timing or otherwise productivity issue. In particular, if the agent keeps the interaction in their personal workspace until the customer responds, the interaction then occupies a slot out of their (and the underlying system's) defined capacity for an unknown amount of time. This means lower productivity and utilization for the agent (and increased requirement for systems resources) because the contact might respond within a large window of time (e.g., within 2 hours), during which the agent could have handled other tasks, making them more productive and better utilized and freeing system resources. Conventional call centers can choose to tolerate the lower productivity/utilization for the sake of keeping interaction with the same agent. However, it is more efficient to achieve higher productivity and utilization by disposing/terminating agent-contact interaction or connection. However, this can create a secondary problem when the customer responds at a later time; in such a scenario, the contact's response may be designated as a new interaction which is routed using a conventional FIFO (or other method) method and therefore such connection is highly likely to get assigned to an agent different than the one who handled the original interaction. The new agent is then required to read through the entire history, customer information, and actions taken by the previous agent in order to provide adequate service, and might even ask questions and suggest similar solutions to ones that were already offered, leading to poor customer experience and/or waste of time (and a waste of underlying computing resources of the contact center) for both the agent and customer which also affects productivity and utilization of the contact center and its underlying computational hardware.

To overcome these issues of conventional contact centers, present disclosure provides for the agent utilization monitor 210 to dynamically determine an agent's capacity based on the number of active interactions and dormant interactions currently handled by the agent. The agent utilization monitor 210 may combine the number of active interactions and dormant interactions a particular agent has to yield a total capacity of the agent. In some examples, each conversation may be associated with a weight, value, score, or pattern; and the weights, values, scores, or patterns of all conversations with the agent may be combined to yield a total capacity of the agent. In some aspects, the total capacity of an agent also defines or is determined by a utilization indicator or engagement indicator of the agent. The total capacity of the agent may determine whether or not the agent has available capacity to accept additional interaction assignments, and this total capacity may be a dynamic allocation between the active interactions and the dormant interactions currently assigned to the agent. Additionally, or alternatively, a utilization indicator subtracted from the total capacity of the agent may determine whether or not the agent has available capacity to accept additional interaction assignments, and this total capacity may be a dynamic allocation between the active interactions and the dormant interactions currently assigned to the agent. The total capacity of the agent is further dynamic in that the weight, value, score, or pattern of each conversation may be determined based on first data about said conversation available at a first time that the determination was made; and a subsequent capacity determination may obtain a different weight, value, score, or pattern for said conversation based on second data about said conversation available at a second time that the subsequent capacity determination was made.

As a result, the agent utilization monitor 210 enables a contact system to assign contacts to agents based on a dynamic interpretation of the agent's total capacity, such as predicted response times for each of the agent's assigned interactions (active and dormant). Thus, the dynamic agent capacity determinations made by the agent utilization monitor overcome the issues experienced by conventional static systems that have a single maximum for active/dormant interactions without considering the idiosyncrasies/practical realities of each active and dormant interaction assigned to an agent.

The contact activity monitor 220 may generally analyze information associated with a contact (e.g., contact system 270) in order to determine a conversation pattern of the contact (e.g., as used herein, “pattern” may also refer to a value, weight, or score). The conversation pattern of a contact may generally indicate a level of interaction/engagement required from an agent in order to successfully dispose and/or otherwise terminate the interaction. In one example, a conversation pattern for a first contact may indicate that an agent may need to respond relatively quickly (e.g., within 1 minute or less) to the first contact, and that the entire interaction may take place over a relatively short timeframe (e.g., 10 minutes or less). In this example, the messaging feature server 140 may analyze response times and interaction disposition times for three agents (e.g., a first agent, a second agent, and a third agent), and may determine that the second agent has a typical response time and interaction disposition time that is similar to the conversation pattern for the first contact. Thus, the messaging feature server 140 may assign the first contact to the second agent.

The contact activity monitor 220 may obtain/receive information associated with the contact from, for example, the request to initiate the interaction transmitted by the contact, the research module 240, and/or any other suitable location or combinations thereof. For example, the request transmitted by the contact in order to initiate the interaction may include contextual data (e.g., metadata) that the contact activity monitor 220 may analyze to determine a conversation pattern, such as a contact's country, a contact's customer type (e.g., high priority contact, low priority contact, contact requiring extensive interaction with agent, etc.), products purchased by the contact, number of prior interactions with the contact, a contact's age, and/or other suitable contextual data or combinations thereof. Based on this contextual data, the contact activity monitor 220 may determine and/or update a contact's conversation pattern in order for the messaging feature server 140 to assign the contact to an optimal agent.

Additionally, or alternatively, the contact activity monitor 220 may analyze a contact's responses to an agent during an interaction to actively update the contact's conversation pattern. For example, the contact activity monitor 220 may include and/or access a natural language processing (NLP) module (not shown) or other suitable language analysis software in order to analyze (e.g., parse, interpret, etc.) the contact's responses during the interaction. Based on this analysis of the contact's responses, the contact activity monitor 220 may update the contact's conversation pattern to better reflect the current conversation patterns of the contact. In this manner, the contact activity monitor 220 may improve the overall assignment process performed by the messaging feature server 140 by maintaining up-to-date conversation patterns for each contact that the messaging feature server 140 may use to accurately and efficiently assign each contact to an optimal agent for interactions.

To illustrate, a first contact may transmit a request for an interaction to the messaging feature server 140, which may determine/retrieve a first conversation pattern for the first contact based on prior interactions of the first contact. For example, the first conversation pattern may indicate that the first contact typically requires intermittent attention and responsiveness from an agent during an interaction. Accordingly, the messaging feature server 140 may assign the first contact to a first agent that has capacity and normal response times. During the interaction, the first contact may respond to the first agent frequently, and may immediately read the responses provided by the first agent seconds/minutes after the first agent sent them. As a result, the contact activity monitor 220 may update the first contact's conversation pattern to indicate that, in fact, the first contact requires constant attention and responsiveness from an agent during an interaction. Thus, the next time the first contact attempts to initiate an interaction, the messaging feature server 140 may assign the first contact to a second agent who has capacity, and is very responsive to contacts.

FIG. 3 depicts a block diagram of an agent capacity prediction implementation 300 of the messaging feature server 140 of FIG. 1, in accordance with aspects of the present disclosure. The agent capacity prediction implementation 300 includes the agent utilization monitor 210, the contact activity monitor 220, a capacity predictor 310, and a routing engine 320. Generally speaking, the agent capacity prediction implementation 300 determines agent capacities using the agent utilization monitor 210, determines conversation patterns of contacts using the contact activity monitor 220, predicts which agent(s) would be optimal to handle the contact's interaction based on the agent capacities and conversation patterns using the capacity predictor 310, and assigns the contact to an agent based on the prediction using the routing engine 320.

The capacity predictor 310 may comprise computing instructions stored in memory and configured to execute one or more processors within, or communicatively coupled to, the contact center system 100A and the message feature server 140. Generally, the capacity predictor 310, may be integrated with (e.g., stored in memory with or as part of a set of computing instructions or application with) the message feature server 140. However, in certain aspects, the capacity predictor 310 may be implemented by a separate computing device (e.g., a server) communicatively connected (e.g., via a network or cable connection) to the message feature server 140.

As mentioned, the capacity predictor 310 may generally receive inputs from the agent utilization monitor 210 and the contact activity monitor 220 to output data corresponding to the contact that enables the routing engine 320 to assign the contact to a suitable agent. More specifically, the capacity predictor 310 may receive agent capacities from the agent utilization monitor 210 and conversation patterns from the contact activity monitor 220 as inputs, and the capacity predictor 310 may output a prediction of an expected capacity of an agent. In certain instances, the prediction of an expected capacity of an agent output by the capacity predictor 310 may include and/or otherwise indicate a predicted compatibility between the agent and the contact (e.g., a predicted contact-agent match). Additionally, or alternatively, the capacity predictor 310 may receive inputs from the agent utilization monitor 210 and the contact activity monitor 220, and the capacity predictor 310 may output the predicted contact-agent match. In any event, the routing engine 320 may receive the output of the capacity predictor 310, and the routing engine 320 may proceed to assign the contact to an agent based on the output of the capacity predictor 310.

As an example, a first contact may request initiation of an interaction, and the contact activity monitor 220 may determine a conversation pattern for the first contact. The agent utilization monitor 210 may also determine agent capacities of agents connected to the contact center system, including a first agent and a second agent. The capacity predictor 310 may receive the conversation pattern for the first contact as well as the agent capacities for the agents connected to the contact center system, including the first agent and the second agent, and the capacity predictor 310 may compare the agent capacity for the first agent with the agent capacity for the second agent. The capacity predictor 310 may determine that the first agent has more capacity than the second agent, but that either agent has sufficient capacity to handle an additional interaction. In some examples, the capacity predictor 310 may compare the agent capacity for the first agent with the agent capacity for the second agent based on the conversation pattern for the first contact. For example, the capacity predictor 310 may analyze the first agent capacity and the second agent capacity in view of the conversation pattern for the first contact to determine predictions of expected capacities of the first and second agents that indicate which agent would provide service that better fits the requirements of the first contact. In this example, the capacity predictor 310 may determine predictions of expected capacities of the first and second agents indicating that the second agent would be a better fit for the first contact, despite the first agent having more capacity at the time when the first contact requests initiation of an interaction. The second agent may, for example, have response times that better align with the expected response time requirements of the first contact, or the second agent may have prior experience with the first contact. Regardless, as illustrated in this example, the capacity predictor 310 determines optimal contact-agent pairings based on agent capacities, as well as conversation patterns of contacts, in a manner that facilitates vastly improved contact-agent interactions and contact experiences overall when compared to conventional techniques.

The capacity predictor 310 may be trained using data corresponding to contacts and agents. Namely, the capacity predictor 310 may be trained using a training dataset comprising historical contact-agent interaction data, agent capacities, and conversation patterns of contacts. This historical contact-agent interaction data may include historical data related to a contact's and/or an agent's interactions with agent's/contact's during interactions, such as message frequency, messages from the contact/agent, contextual information (e.g., contact country, products purchased by the contact, number of prior interactions with the contact), and/or other suitable historical interaction data or combinations thereof. Using this training dataset, the capacity predictor 310 may be trained to output the prediction of an expected capacity of an agent.

Generally speaking, the prediction output by the capacity predictor 310 may indicate an optimal contact-agent pairing that the routing engine 320 may use to assign the contact to an agent, and the output may also indicate/include a pattern or weighting corresponding to the contact related to interaction requirements of the contact. For example, an output of the capacity predictor 310 may indicate that a contact requires little responsiveness from an agent because the contact prefers to conduct interactions through text message over the course of several days. As another example, an output of the capacity predictor 310 may indicate that a contact requires higher than average responsiveness from an agent because the contact prefers to conduct interactions through email over the course of several minutes. In this manner, the capacity predictor 310 and routing engine 320 may intelligently allocate system resources appropriately by shifting and/or otherwise assigning contacts to agents that are more efficient based on the requirements of the specific contacts.

Additionally, or alternatively, the capacity predictor 310 may be or include a machine learning (ML) model configured to receive inputs from the agent utilization monitor 210 and the contact activity monitor 220 and output a prediction of an expected capacity of an agent. For example, the capacity predictor 310 may include a machine learning model, or algorithm for training a machine learning model, that is configured to receive historical contact-agent interaction data, agent capacities, and/or conversation patterns of contacts as input in order to output predictions of expected capacities of agents and/or contact-agent pairings, as described herein. The capacity predictor 310 may be trained to determine optimal contact-agent pairings that are included as part of the predictions of expected capacities of agents. In various aspects, a machine learning model of the capacity predictor 310 may be trained using a reinforcement machine learning program or algorithm, a supervised machine learning program or algorithm, or an unsupervised machine learning program or algorithm. The machine learning program or algorithm may employ, for example, a state-action-reward-state (SARS) algorithm, which may be a state-action-reward-state-action (SARSA) algorithm. In some aspects, the artificial intelligence and/or machine learning based algorithms, as used to train the capacity predictor 310, may be included as a library. For example, libraries may include the TENSORFLOW based library, the PYTORCH library, and/or the SCIKIT-LEARN Python library.

Machine learning as applied to the capacity predictor 310 may involve identifying and recognizing patterns in existing data, such as historical contact-agent interaction data, agent capacities, and conversation patterns of contacts, in order to facilitate making predictions or identification for subsequent data (such as predicting expected capacities of agents and/or contact-agent pairings). For example, a machine learning model, such as the machine learning model of the capacity predictor 310, as described herein, may be created and trained based upon training data (e.g., data or information regarding contacts, agents, arrival times, log in or log out times, handle times, sales or transaction information, telecommunication connection status or utilization, memory or processor resource utilization of the contact center system, or other information or data described herein) as inputs or data (which may be termed “features” and “labels”) in order to make valid and reliable predictions for new inputs, such as testing level or production level data or inputs (e.g., for predicting expected capacities of agents and/or contact-agent pairings).

Generally speaking, in reinforcement machine learning, a machine learning program operating on a server, computing device, or otherwise processors, is tasked with performing actions (e.g., predicting expected capacities of agents) in an environment in order to maximize a cumulative “reward”. Reinforcement learning does not require labelled input/output pairs be presented, and similarly does not rely upon explicit corrections to sub-optimal actions. Instead, reinforcement learning primarily focuses on determining a balance between exploration of unknown relationships and exploitation of known relationships. Many reinforcement learning algorithms also use dynamic programming techniques, and the environment is typically stated in the form of a Markov decision process (MDP).

In supervised machine learning, a machine learning program operating on a server, computing device, or otherwise processors, may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on a server, computing device, or otherwise processors as described herein, to predict or classify, based on the discovered rules, relationships, or model, an expected output, score, or value.

In unsupervised machine learning, the server, computing device, or otherwise processors, may be required to find its own structure in unlabeled example inputs, where, for example multiple training iterations are executed by the server, computing device, or otherwise processors to train multiple generations of models until a satisfactory model, e.g., a model that provides sufficient prediction accuracy when given test level or production level data or inputs, is generated.

Reinforcement learning, supervised learning, and/or unsupervised machine learning may also comprise retraining, relearning, or otherwise updating models with new, or different, information, which may include information received, ingested, generated, or otherwise used over time. The disclosures herein may use one or more of such reinforcement, supervised, or unsupervised machine learning techniques.

It is to be understood that capacity predictor 310 may be used to determine predictions of expected agent capacity, using artificial intelligence (e.g., a machine learning model of capacity predictor 310) or, in alternative aspects, without using artificial intelligence.

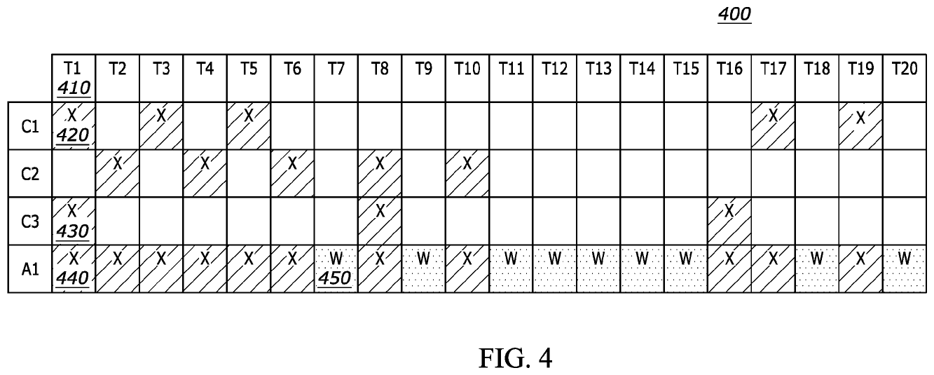

FIG. 4 illustrates an example interaction sequence 400 between an agent A1 and several contacts C1, C2, C3, where the wait time experienced by the agent A1 and contacts C1, C2, C3 may be identified and minimized by the techniques of the present disclosure, in accordance with aspects of the present disclosure. Generally, the example interaction sequence 400 illustrated in FIG. 4, includes an agent A1 interacting with three contacts C1, C2, C3 across a period of time extending from t1 to t20 (e.g., the agent's A1 shift). The agent A1 may be interacting with the three contacts C1, C2, C3 across three separate connections of a single communication channel (e.g., text message, email, Internet chat, etc.) or across three separate connections of multiple different communication channels. For instance, the agent A1 may interact with contact C1 across a text message communication channel while the agent A1 communicates with contacts C2, C3 through their separate email accounts. As another example, the agent A1 may communicate with all contacts C1, C2, C3 through text messaging to each individual contact's C1, C2, C3 phone. As another example, the agent A1 may communicate with all contacts C1, C2, C3 through multiple channels (e.g., web chat, text, video, email, and/or voice, etc.) for each individual contact C1, C2, C3.

In any event, as illustrated in FIG. 4, each of the time periods t1-t20 may represent 30 second time intervals, such that the entire time period extending from t1-t20 represents 10 minutes. Of course, it should be understood that the time periods t1-t20 may represent any suitable periods of time (e.g., seconds, minutes, hours, etc.), such that the entire time period extending from t1-t20 represents any suitable time period. In the example interaction sequence 400, both contact C1 and contact C3 may initially be responsive to the agent, as represented by the “x” indicator or otherwise patternings in boxes 420 and 430. It should be appreciated that the indicator and/or patternings in boxes 420, 430, and 440 are generally representative of a contact C1, C2, C3 or the agent A1 interacting as part of a respective interaction, such that any box including such a similar indicator and/or patterning (e.g., contact C1 boxes at times t3, t5, t17, and t19, etc.) similarly represents the respective contact C1, C2, C3 or agent A1 interacting as part of a respective interaction.

The agent A1 may respond to one or both of the contacts C1, C3 during time period t1, as represented by the similar indicator and/or patterning in box 440. Thereafter, all contacts C1, C2, C3 may vary in their responsiveness. For example, contact C1 is initially responsive at time periods t1, t3, and t5, and then has a long gap in responsiveness until times t17 and t19. Contact C2 consistently responds in the beginning of the time period at times t2, t4, t6, t8, and t10, but then does not respond for the remainder of the time period extending from t11-t20. Contact C3 is generally less responsive than either contact C1 or C2, and only interacts with the agent A1 at times t1, t8, and t16.

Accordingly, as illustrated in FIG. 4, the agent A1 eventually has a significant amount of idle time while waiting for any of contacts C1, C2, C3 to respond. Namely, the agent A1 is sitting idle during time periods t7 (as indicated by the indicator and/or patterning in box 450), t9, t11-t15, t18, and t20. It should be appreciated that the “w” indicator or otherwise patterning in box 450 is generally representative of the agent A1 waiting or otherwise sitting idle (e.g., not interacting as part of a respective interaction), such that any box including such a similar indicator and/or patterning (e.g., agent A1 boxes at times t9, t11-t15, t18, and t20) similarly represent the agent A1 sitting idle. Thus, in the example interaction sequence 400, the agent A1 is sitting idle during 45% of the agent's A1 shift, and the agent's A1 time is therefore under-utilized.

To minimize issues similar to the underutilization illustrated by the example interaction sequence 400 of FIG. 4, the systems and methods of the present disclosure may optimize the agent's assigned interactions to provide the agent A1 with an opportunity to conduct additional interactions in the event that the agent A1 is sitting idle for significant periods of time (e.g., t11-t15 for agent A1) where the agent A1 could otherwise be interacting with a contact. For example, the agent utilization monitor 210 of FIGS. 2 and 3 may determine that at least the interaction with contact C1 has become dormant by t11, such that the agent A1 has capacity for a new active interaction. Accordingly, the capacity predictor 310 of FIG. 3 may identify a contact (e.g., C4) with a conversation pattern determined by the contact activity monitor 220 that aligns well with the agent's A1 capacity, as described herein, and the routing engine 320 may assign the contact C4 to the agent A1. In this manner, the agent's A1 utilization may increase as a result of the systems and methods of the present disclosure enabling the agent A1 to interact with contact C4, for example, during the time period extending from t11-t15, when the agent A1 would otherwise sit idle.

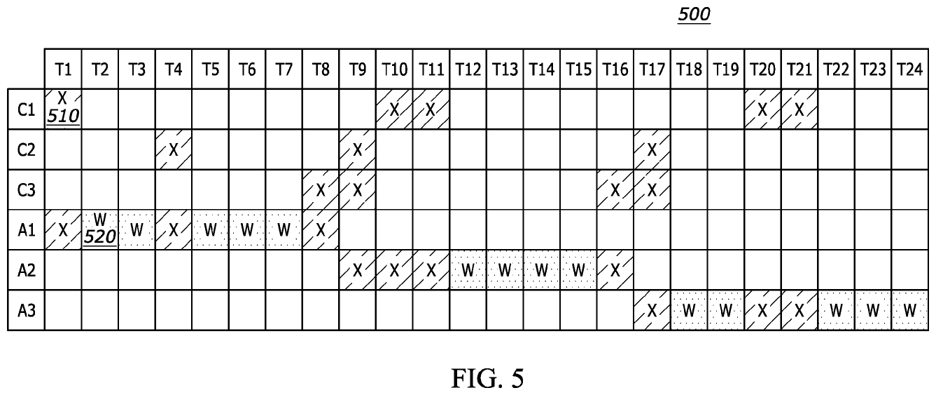

FIG. 5 illustrates another example interaction sequence 500 between multiple agents A1, A2, A3 and multiple contacts C1, C2, C3, where the wait time experienced by each agent A1, A2, A3 and each contact C1, C2, C3 may be identified and minimized by the techniques of the present disclosure, and in accordance with aspects of the present disclosure. Generally, the example interaction sequence 500 illustrated in FIG. 5, includes three agents A1, A2, A3 interacting with three contacts C1, C2, C3 across a period of time extending from t1 to t24 (e.g., a 24 hour period including each agent's A1, A2, A3 shift). The agents A1, A2, A3 may be interacting with the three contacts C1, C2, C3 across three separate connections of a single communication channel (e.g., text message, email, Internet chat, etc.) or across three separate connections of multiple different communication channels. For instance, the agent A1 may interact with contact C1 across a text message communication channel while the agent A1 communicates with contacts C2, C3 through their separate email accounts. As another example, the agent A3 may communicate with all contacts C1, C2, C3 through text messaging to each individual contact's C1, C2, C3 phone. As another example, the agent A1 may communicate with all contacts C1, C2, C3 through multiple channels (e.g., web chat, text, video, email, and/or voice, etc.) for each individual contact C1, C2, C3.

In any event, as illustrated in FIG. 5, each of the time periods t1-t24 may represent 1 hour time intervals, such that the entire time period extending from t1-t24 represents 24 hours. Of course, it should be understood that the time periods t1-t24 may represent any suitable periods of time (e.g., seconds, minutes, hours, etc.), such that the entire time period extending from t1-t24 represents any suitable time period. In the example interaction sequence 500, contact C1 may initially be responsive to agent A1, as represented by the indicator and/or patterning in box 510. It should be appreciated that the indicator and/or patterning in box 510 is generally representative of a contact C1, C2, C3 or an agent A1, A2, A3 interacting as part of a respective interaction, such that any box including such a similar indicator and/or patterning (e.g., contact C2 boxes at times t4, 19, t17, etc.) similarly represents the respective contact C1, C2, C3 or agent A1, A2, A3 interacting as part of a respective interaction.

The agent A1 may respond to the contact C1 during time period t1, and afterwards, all contacts C1, C2, C3 may respond very little until the end of the agent's A1 shift at the transition between time periods t8 and t9, when agent A2 assumes responsibility for the interactions with each of the contacts C1, C2, C3 from agent A1. Each contact C1, C2, C3 may similarly respond very little to agent A2 until the end of the agent's A2 shift at the transition between time periods t16 and t17, when agent A3 assumes responsibility for the interactions with each of the contacts C1, C2, C3 from agent A3. Further, each contact C1, C2, C3 may similarly respond very little to agent A3 until the end of the agent's A3 shift at time period t24.

As a result of the lack of responsiveness from the contacts C1, C2, C3, each of agents A1, A2, A3 sat idle for at least 50% of their respective shifts. Namely, agent A1 was sitting idle during time periods t2 (as indicated by the indicator and/or patterning in box 520), t3, and t5-t7. It should be appreciated that the indicator and/or patterning in box 520 is generally representative of the agent A1 sitting idle (e.g., not interacting as part of a respective interaction), such that any box including such a similar indicator and/or patterning (e.g., agent A2 boxes at times t12-t15, etc.) similarly represent an agent A1, A2, A3 sitting idle. Moreover, agent A2 was sitting idle during time periods t12-t15, and agent A3 was sitting idle during time periods t18, t19, and t22-t24. Thus, in the example interaction sequence 500, each agent's A1, A2, A3 time is under-utilized.

To minimize issues similar to the underutilization illustrated by the example interaction sequence 500 of FIG. 5, the systems and methods of the present disclosure may optimize each agent's A1, A2, A3 assigned interactions to provide the agents A1, A2, A3 with an opportunity to conduct additional interactions in the event that the agent A1, A2, A3 is sitting idle for significant periods of time (e.g., t12-t15 for agent A2) where the agent A1, A2, A3 could otherwise be interacting with a contact. For example, the agent utilization monitor 210 of FIGS. 2 and 3 may determine that at least the interactions with contacts C2 and C3 have become dormant for agent A3 by t22, such that the agent A3 has capacity for one or more new active interactions. Accordingly, the capacity predictor 310 of FIG. 3 may identify contacts (e.g., C4 and C5) with conversation patterns determined by the contact activity monitor 220 that align well with the agent's A3 capacity, as described herein, and the routing engine 320 may assign the contacts C4, C5 to the agent A3. In this manner, the agent's A3 utilization may increase as a result of the systems and methods of the present disclosure enabling the agent A3 to interact with contacts C4, C5, for example, during the time period is extending from t22-t24, when the agent A3 would otherwise sit idle.

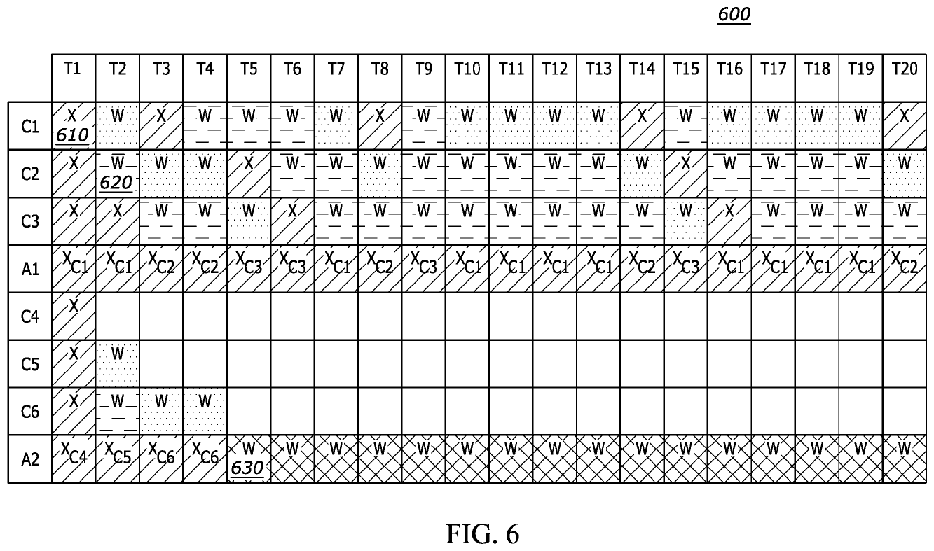

FIG. 6 illustrates yet another example interaction sequence 600 between two agents A1, A2 each simultaneously handling multiple contacts C1-C6, where the wait time experienced by each agent A1, A2 and each contact C1-C6 may be identified and minimized by the techniques of the present disclosure, in accordance with aspects of the present disclosure. Generally, the example interaction sequence 600 illustrated in FIG. 6, includes two agents A1, A2 each interacting with three contacts C1-C6 across a period of time extending from t1 to t20 (e.g., the agent's A1, A2 shifts or a portion of their shifts). The agents A1, A2 may be interacting with the three contacts C1-C6 across three separate connections of a single communication channel (e.g., text message, email, Internet chat, etc.) or across three separate connections of multiple different communication channels. For instance, the agent A1 may interact with contact C1 across a text message communication channel while the agent A1 communicates with contacts C2, C3 through their separate email accounts. As another example, the agent A2 may communicate with all contacts C4, C5, C6 through text messaging to each individual contact's C4, C5, C6 phone. As another example, the agent A1 may communicate with all contacts C1, C2, C3 through multiple channels (e.g., web chat, text, video, email, and/or voice, etc.) for each individual contact C1, C2, C3.

In any event, as illustrated in FIG. 6, each of the time periods t1-t20 may represent 30 second time intervals, such that the entire time period extending from t1-t20 represents 10 minutes. Of course, it should be understood that the time periods t1-t20 may represent any suitable periods of time (e.g., seconds, minutes, hours, etc.), such that the entire time period extending from t1-t20 represents any suitable time period. In the example interaction sequence 600, each of the contacts C1, C2, C3 may initially respond to the agent A1, as represented by the indication and/or patterning in box 610. It should be appreciated that the indicator and/or patterning in box 610 is generally representative of a contact C1-C6 interacting as part of a respective interaction, such that any box including such a similar indication and/or patterning (e.g., contact C4 box at time t1, etc.) similarly represents the respective contact C1-C6 interacting as part of a respective interaction.

The agent A1 may respond to the contact C1 at time t1, and may continue responding to C1 at time t2 (e.g., x_{C1} for the agent A1 at times t1, t2), such that contact C2 is left waiting for the agent A1 to respond at time t2 after contact C2 sends an initial inquiry to agent A1 at time t1. Contact C3 may continue send a longer initial inquiry to the agent A1 at times t1 and t2. The contact C2 waiting for the agent's A1 response at time t2 is represented by the indication and/or patterning in box 620. It should be appreciated that the indicator and/or patterning in box 620 is generally representative of a contact C1-C6 waiting for a response from an agent A1, A2 while the agent A1, A2 is responding to another contact C1-C6, as part of a respective interaction. Accordingly, any box including such a similar indication or patterning (e.g., contact C3 boxes at times t3, t4, t7-t14, t17-t20, etc.) similarly represents the respective contact C1-C6 waiting for a response from an agent A1, A2, as part of a respective interaction. Regardless, the agent A1 may be occupied by responding to the contacts C1, C2, C3 throughout the time period extending from t1 to t20, but the contacts C1, C2, C3 may nevertheless spend a significant amount of time waiting for a response from the agent A1.

By contrast, the contacts C4, C5, C6 may spend very little time responding and/or waiting for responses to/from the agent A2. In fact, the agent A2 may provide a final response to contact C6 at time t4, after which, the agent A2 is sitting idle during the time period extending from t5 (as indicated by the indication and/or patterning in box 630) to t20. It should be appreciated that the indication and/or patterning in box 630 is generally representative of the agent A2 sitting idle (e.g., not interacting as part of a respective interaction), such that any box including such a similar indication and/or patterning (e.g., agent A2 boxes at times t6-t20) similarly represent the agent A2 sitting idle. Consequently, and as a result of the lack of responsiveness from the contacts C4, C5, C6, the agent A2 may sit idle for 80% of the agent's A2 respective shift. Thus, in the example interaction sequence 600, the agent's A2 time is under-utilized, while the agent A1 is overloaded with the interactions corresponding to contacts C1, C2, C3. In other words, the contacts C1-C6 are non-optimally distributed between the agents A1, A2.

To minimize issues similar to the non-optimal distribution illustrated by the example interaction sequence 600 of FIG. 6, the systems and methods of the present disclosure may optimize each agent's A1, A2 assigned interactions to provide the agents A1, A2 with an opportunity to conduct additional and/or offload interactions because the agent A2 is sitting idle for significant periods of time (e.g., t5-t20 for agent A2) where the agent A2 could otherwise be interacting with a contact C1, C2, C3. For example, the agent utilization monitor 210 of FIGS. 2 and 3 may determine that at least the interactions with any of contacts C4, C5, C6 have become dormant for agent A2 by, for example, t5, t6, or t7, such that the agent A2 has capacity for one or more new active interactions. Accordingly, the capacity predictor 310 of FIG. 3 may identify contacts (e.g., C1, C2, or C3) with conversation patterns determined by the contact activity monitor 220 that align well with the agent's A2 capacity, as described herein, and the routing engine 320 may assign one or more of the contacts C1, C2, C3 to the agent A2, or re-assign one or more of the contacts C1, C2, C3 from the agent A1 to the agent A2. In this manner, the agent's A2 utilization may increase as a result of the systems and methods of the present disclosure enabling the agent A2 to interact with contacts C1, C2, or C3, for example, during the time period extending from t5-t20, when the agent A2 would otherwise sit idle. In this manner, the agent's A1 utilization may decrease as a result of the systems and methods of the present disclosure, allowing for a more balanced utilization among agents in the contact center system.

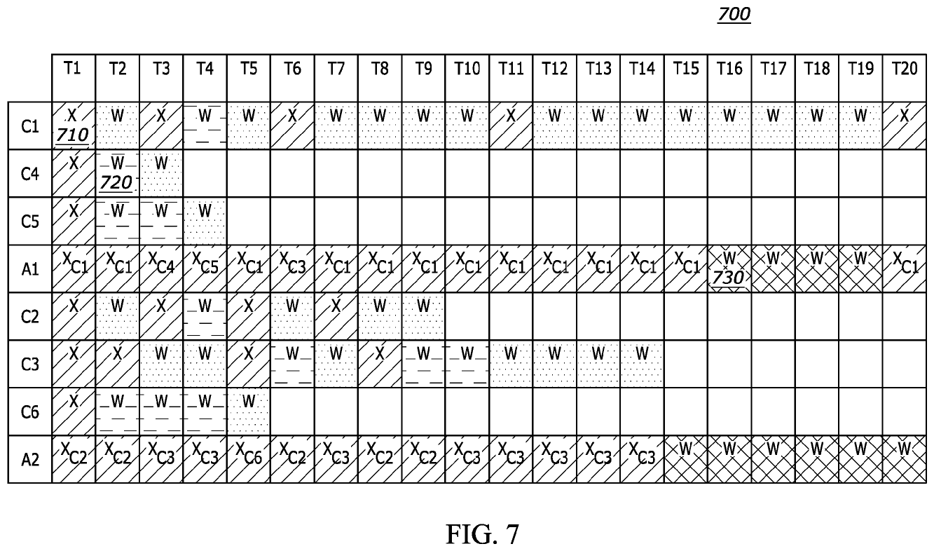

To demonstrate this point, FIG. 7 illustrates an example optimized interaction sequence 700 between the two agents A1, A2 and the multiple contacts C1-C6 of FIG. 6, in accordance with aspects of the present disclosure. Unlike the example interaction sequence 600 of FIG. 6, the example optimized interaction sequence 700 features the agent A1 conducting interactions with contacts C1, C4, and C5, and the agent A2 conducting interactions with contacts C2, C3, and C6. As illustrated in FIG. 7, assigning the contacts C1-C6 in this manner results in the agents A1, A2 only sitting idle for 20% and 30%, respectively, of their respective shifts. For example, the capacity predictor 310 of FIG. 3 may output selected pairings shown in FIG. 7 based on historical contact-agent interaction data, such as the data shown in FIG. 6.

Namely, each of contacts C1, C4, and C5 initially respond to agent A1 (as indicated by the indication and/or patterning in box 710). It should be appreciated that the indicator and/or patterning in box 710 is generally representative of a contact C1-C6 interacting as part of a respective interaction, such that any box including such a similar indicator and/or patterning (e.g., contact C4 box at time t1, etc.) similarly represents the respective contact C1-C6 interacting as part of a respective interaction. Thereafter, the contacts C4 and C5 stop responding to the agent A1, leaving the agent A1 available to respond to the contact C1 during the remainder of the agent's A1 shift extending from time t5 to t20.

Each of the contacts C1, C4, and C5 may also have a significantly reduced wait time as a result of the example optimized interaction sequence 700 as compared to the interaction sequence 600, as none of the contacts C1, C4, C5 are forced to wait for longer than 2 successive time periods (or 2 time periods in total), as represented by the indicator and/or patterning in box 720. It should be appreciated that the indicator and/or patterning in box 720 is generally representative of a contact C1-C6 waiting for a response from an agent A1, A2 while the agent A1, A2 is responding to another contact C1-C6, as part of a respective interaction.

Accordingly, any box including such a similar indication and/or patterning (e.g., contact C5 boxes at times t2, t3, etc.) similarly represents the respective contact C1-C6 waiting for a response from an agent A1, A2, as part of a respective interaction. Additionally, the agent A1 may also have a significantly reduced idle time, as represented by the indicator and/or patterning in box 730. It should be appreciated that the indication and/or patterning in box 730 is generally representative of the agent A1 sitting idle (e.g., not interacting as part of a respective interaction), such that any box including such a similar indication and/or patterning (e.g., agent A2 boxes at times t15-t20) similarly represent the agent A2 sitting idle.

Similarly, each of contacts C2, C3, C6 may initially respond to agent A2, and the agent A2 may proceed to respond to each contact C2, C3, C6 in turn. The interactions for each of the contacts C2, C3, C6 may continue based on the responses provided by the agent A2, and the agent A2 may successfully dispose of each interaction by time t15. Accordingly, the contacts C2, C3, C6 may only wait for up to 3 time periods each, and the agent A2 may only sit idle for 30% of the agent's A2 shift. Thus, as illustrated by the example optimized interaction sequence 700 of FIG. 7, the systems and methods of the present disclosure optimized the example interaction sequence 600 of FIG. 6 by determining how to re-organize the contacts C1-C6 between the agents A1, A2 in a manner that simultaneously minimizes the wait time for each contact C1-C6 and reduces the overall idle time of the agents A1, A2 during the time period extending from t1 to t20.

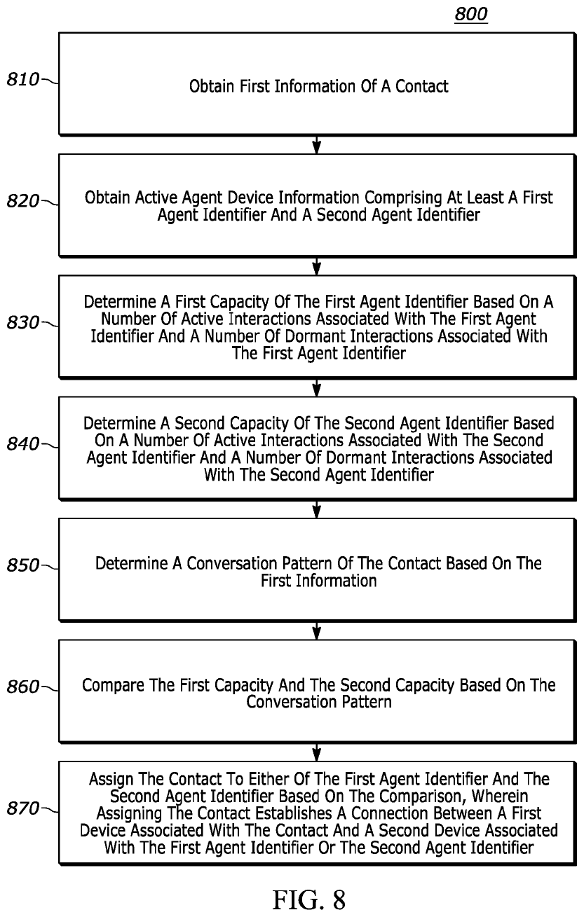

FIG. 8 illustrates a method 800 for determining agent capacity for managing contact interactions, in accordance with various aspects of the present disclosure. The method 800 comprises an algorithm or computing instructions, as may be implemented in a contact center or contact center system (e.g., contact center system 100A), and may involve the processing of input data and the generation of output data, both of which may comprise call center related data, including data regarding agents, contacts (or events thereof, including arrival of contacts and/or capacity of agents), and/or determination/prediction of expected agent capacities, conversation patterns, and other data, as described herein. Input data and output data receipt, transmission, and/or generation may be implemented in hardware or software components of a contact center system. For example, specific electronic components may be employed in a reinforcement learning algorithm, as implemented on one or more processors and/or memories of a contact center system, or similar or related circuitry for implementing the functions associated with determining/predicting expected agent capacities and assigning contacts to agents in a contact center system (e.g., contact center system 100A). Additionally, one or more processors operating in accordance with computing instructions may implement the functions associated with determining/predicting expected agent capacities and assigning contacts to agents in a contact center system (e.g., contact center system 100A) as described herein, including for method 800. Such instructions may be stored on one or more non-transitory processor readable storage media (e.g., a magnetic disk or other storage medium), or transmitted to one or more processors via one or more signals embodied in one or more carrier waves, for example, across one or more computer buses and/or computer networks. In various aspects, the one or more processors that implement the algorithm of method 800, or otherwise execute the computing instructions as described herein, may comprise one or more processors of a computing device of the contact center system itself, such as one or more processors of a computing device, server (e.g., messaging feature server 140), router, or the like that is communicatively coupled to the contact center system.

The method 800 includes obtaining, by a communications server (e.g., the messaging feature server 140), first information of a contact (block 810). In certain aspects, the first information comprises at least one of a message text and contextual data associated with the message text. The message text may include the text of messages sent by the contact during interactions with agents, and/or may include other data. For example, the message text may include a contact's response time in the current interaction, the contact's text prompts indicating a certain response time (e.g., “I will respond tomorrow” or “I'll get back to you in the evening”), a contact's reason for the interaction (broken product vs a sales inquiry), and/or other similar data or combinations thereof. The contextual data associated with the message text may include a contact's country, a contact's customer type (e.g., high priority contact, low priority contact, contact requiring extensive interaction with agent, etc.), products purchased by the contact, number of prior interactions with the contact, and/or other suitable data or combinations thereof.

The method 800 includes obtaining, by the communications server, active agent device information comprising at least a first agent identifier and a second agent identifier (block 820). Generally speaking, the active agent device information may be or include data indicating agents that are on-line and either currently conducting active/dormant interactions with contacts or that are waiting to receive an assigned contact to begin conducting an interaction. The agent identifiers may be or include unique identification numbers/codes/etc. that correspond to individual agents. For example, the first agent identifier may uniquely identify a first agent, and the second agent identifier may uniquely identify a second agent who is different from the first agent. In this manner, the communications server may identify agents who are potentially available to conduct an interaction with the contact.

The method 800 includes determining a first capacity of the first agent identifier based on a number of active interactions associated with the first agent identifier and a number of dormant interactions associated with the first agent identifier (block 830). Similarly, the method 800 includes determining a second capacity of the second agent identifier based on a number of active interactions associated with the second agent identifier and a number of dormant interactions associated with the second agent identifier (block 840). As described herein, the number of active interactions and dormant interactions are considered collectively in order to determine the agent capacity of the first and second agents. The number of active interactions, the number of dormant interactions, and the number of total interactions (active and dormant interactions combined) permitted for agents may vary by contact center, and even by agent. In one embodiment, an active interaction may have a first weight, and a dormant interaction may have a second weight, lower than the first weight.

The method 800 includes determining a conversation pattern of the contact based on the first information (block 850). In certain aspects, determining the conversation pattern of the contact includes obtaining historical contact-agent interaction data, and determining the conversation pattern of the contact based on the historical contact-agent interaction data. For example, in some aspects, the historical contact-agent interaction data is associated with the contact, and may include data such as response time patterns associated with and/or related to any of the following: previous interactions involving the contact 105, a current interaction for the contact 105, the contact 105 or other contacts when participating in a interaction about a specific topic, the contact 105 and/or all contacts in the specific messaging channel after a suitable number of messages, the contact 105 based on a number of previous interactions, the contact 105 based on a number of words used in a sentence, the contact 105 based on sentiment (e.g., via text analysis) of the interaction, the contact 105 based on an urgency of the issue discussed in the interaction, interactions stored in the interaction queue, the contact's 105 main language and the contact's 105 conversation language, the device type of a device utilized by the contact 105 to conduct the interaction, and/or interactions with contact typing mistakes.

In some aspects, the historical contact-agent interaction data is based on information from at least one other contact, where the at least one other contact is different from the contact. For example, the historical contact-agent interaction data in these aspects may include response time patterns associated with and/or related to any of the following: contacts that have a similar contact type to the contact 105, contacts during the same day when the contact 105 attempts to initiate an interaction with an agent 130A-D, contacts during a similar time (e.g., time of day or specific date/time) when the contact 105 attempts to initiate an interaction with an agent 130A-D, contacts in the specific messaging channel (e.g., text messaging, Internet chat, email, etc.) in which the contact 105 attempts to initiate an interaction with an agent 130A-D, and/or contacts conducting interactions with the same and/or similar device type to the contact 105.

In some aspects, determining the conversation pattern further includes determining an interaction handle time for the contact. The interaction handle time may generally correspond to the amount of time a contact will participate in an interaction with an agent before the interaction terminates. For example, a first contact that typically participates in interactions lasting longer than 1 hour may have an associated interaction handle time of over 1-2 hours. A second contact that typically participates in interactions lasting less than 10 minutes may have an associated interaction handle time of 5-10 minutes.

In certain aspects, determining the conversation pattern further includes determining a response rate variability for the contact. The response rate variability may generally correspond to a variability in the length of time between responses of a contact. In other words, the response rate variability indicates the variability in response time between subsequent responses as a single user progresses through a conversation with an agent. For example, if a first contact consistently responds quickly to agents during a first stage of an interaction, but then respond slowly during a second stage of the interaction, and then responds quickly again during a third stage of the interaction, then the response rate variability of the contact may be relatively high. By contrast, if a second contact consistently responds to agents during interactions every 5 minutes, then the response rate variability of the second contact may be relatively low.

In some aspects, determining the conversation pattern further includes training a machine-learning model (e.g., capacity predictor 310) based on a training dataset comprising historical contact-agent interaction data. In one example, the machine-learning model may be configured to output a prediction of an expected capacity of an agent. In another example, the machine-learning model may be configured to output a selected agent for pairing to an available contact.

In certain aspects, determining the conversation pattern further includes determining a response lag time measurement based on historical contact-agent interaction data associated with a contact type of the contact. The response lag time measurement may generally correspond to a consistent response type (e.g., short, intermittent v. longer timeframe) for a particular contact based on the type of contact interacting with an agent. This response lag time measurement may be roughly predicted based on the historical contact-agent interaction data associated with the contact that may tie the contact to a particular contact type with a known response lag time measurement. For example, if the historical contact-agent interaction data associated with the contact indicates that the contact is likely of a contact type that participates in interactions late at night, and that such contact types typically have a response lag type consistent with infrequent, longer timeframe responses over the course of several hours, then that response lag time measurement may be associated with the contact.

The method 800 includes initiating a comparison of the first capacity and the second capacity based on the conversation pattern (block 860). Further, the method 800 includes assigning the contact to either of the first agent identifier and the second agent identifier based on the comparison (block 870). As part of block 870, assigning the contact may further include establishing a connection between a first device associated with the contact and a second device associated with the first agent identifier or the second agent identifier.

In certain aspects, the method 800 further includes establishing a communication channel across the connection, obtaining a first message at the second device transmitted by the first device, and obtaining a second message at the first device transmitted by the second device. Further in these aspects, the method 800 includes, after obtaining the first message at the second device transmitted by the first device, obtaining second information of the contact. The method 800 may then further include determining an updated capacity of the agent identifier associated with the second device based on the second information of the contact.

In some aspects, the method 800 may further include, after obtaining the first message at the second device transmitted by the first device, determining an expected wait time for obtaining a third message at the second device transmitted by the first device. In these aspects, the expected wait time may be based on the first message. Further, the method 800 may include determining an updated capacity of the agent identifier associated with the second device based on the expected wait time.

In certain aspects, the contact is communicatively coupled to a contact center, and the contact may transmit one or more messages to a third device associated with a third agent identifier.

As previously mentioned, contact response times in interactions (e.g., instant messaging, live chats with agents) depends on several variables such as the time of day, inquiry resolution/response urgency of a contact, season, customer typing skills, and the like. The increasing number of contact-agent interactions recorded every day enables the systems and methods of the present disclosure to model these response times without explicitly extracting features of these interactions, and instead only using response time patterns observed for multiple (e.g., thousands or millions) contacts across substantial time periods (e.g., several months).

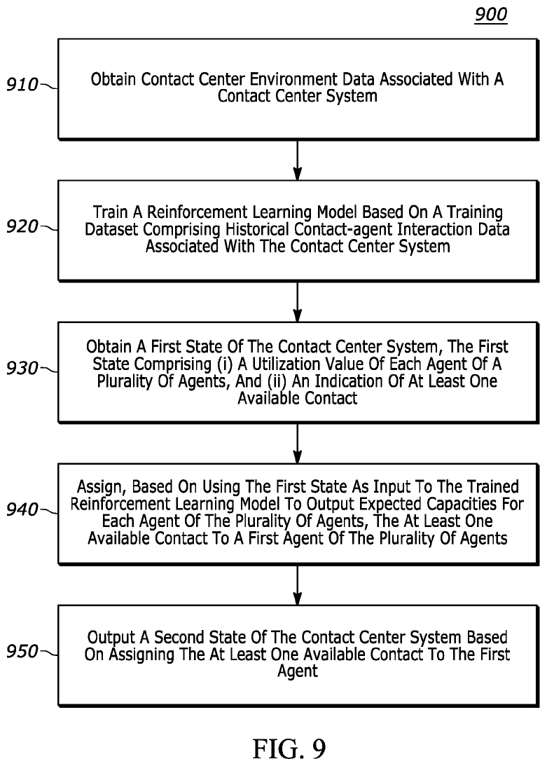

In particular, learning from response time patterns can be used to optimize representative scheduling in messaging. Accordingly, FIG. 9 illustrates a method 900 for allocating contacts to agents, in accordance with various aspects of the present disclosure, in a manner that may assign multiple contacts to the same agent without compromising the ability of the agent to reply effectively to each contact. As an example, assume that a minimum contact message handle time may be 30 seconds, and that the maximum number of contact inquiries an agent can handle in one minute is 2. In this example, an agent time slot of 1 minute can accommodate 2 contacts or a single contact with a response time within 1 minute from the previous replied inquiry.

The method 900 of FIG. 9 may generally assign multiple contacts to the same agent based on reinforcement learning. A contact-agent pairing selection module may be trained to utilize such reinforcement learning with historical contact-agent interaction data and contact response times, and the module may be trained to assign incoming contacts to available agents in a manner that minimizes slot gaps across all available agents, as previously mentioned.

The method 900 may include obtaining contact center environment data associated with a contact center system (block 910). Generally speaking, the contact center environment data may include any of: (i) a number of active conversations associated with one or more agents of the plurality of agents at the contact center system, (ii) a number of dormant conversations associated with one or more agents of the plurality of agents at the contact center system, (iii) a pattern associated with one or more contacts of a plurality of contacts handled by the contact center system, and/or (iv) a message text associated with one or more contacts of a plurality of contacts handled by the contact center system.

The method 900 may include training a reinforcement learning model based on a training dataset (block 920). In one example, the training dataset comprises historical contact-agent interaction data associated with the contact center system. In other examples, the training dataset may comprise synthetic data, data that is a simulation of a contact center environment, and/or data that is simulated from a historical contact-agent interaction data associated with the contact center system.

In one example, the reinforcement learning model may be configured to output a prediction of an expected capacity of an agent. In another example, the reinforcement learning model may be configured to output a contact-agent pairing selection. In certain aspects, training the reinforcement learning model further includes determining a time period associated with an average agent response time per single contact-interaction. Further in these aspects, the training dataset includes the time period, and the time period may be one of: 15 seconds, 30 seconds, 45 seconds, and 1 minute. Of course, it should be understood that these time periods are for the purposes of discussion, and that any suitable time period associated with an average agent response time per single contact-interaction may be included as part of the training dataset of the reinforcement learning model.

In some aspects, training the reinforcement learning model further includes determining at least one positive reward based on at least one of: an agent utilization value and a length of agent utilization. Further in these aspects, the training dataset includes the at least one positive reward, and the at least one positive reward may include (i) an allocation reward based on a number of utilized time slots for a respective agent, and (ii) a time difference between a first time value that a respective agent is available and a second time value that the respective agent handled a final interaction. Additionally, or alternatively, the at least one positive reward may include a total agent reward, comprising a sum of the allocation reward for each respective agent.

In certain aspects, training the reinforcement learning model further includes determining at least one negative reward based on at least one of: an agent wait time and a contact wait time. Further, the training dataset may include the at least one negative reward.

The method 900 may include obtaining a first state of the contact center system (block 930). The first state may include (i) a utilization value of each agent of a plurality of agents, and (ii) an indication of at least one available contact. In some aspects, the method 900 further includes determining a contact arrival event or an agent state change event. Further in these aspects, obtaining the first state of the contact center system occurs after determining the contact arrival event or the agent state change event.

The method 900 may include assigning, based on using the first state as input to the trained reinforcement learning model to output expected capacities for each agent of the plurality of agents, the at least one available contact to a first agent of the plurality of agents (block 940). Generally speaking, and as previously mentioned, the reinforcement learning model is configured to assign incoming contacts to available agents in a manner that minimizes slot gaps across all available agents. More specifically, the reinforcement learning model may be configured to determine rewards that are calculated to guarantee low sparsity between a first available slot of each agent and a last assigned slot of each agent and the assignment of a maximum number of contacts to each agent. In this manner, the reinforcement learning model may achieve a well-distributed assignment of contacts between/among available agents that minimizes the slot gaps across all available agents.

The method 900 may include outputting a second state of the contact center system based on assigning the at least one available contact to the first agent (block 950). Thus, during, for example, subsequent execution of the method 900, the reinforcement learning model may receive the second state of the contact center system as input in order to output the expected capacities of each agent. Thus, as contacts arrive at the contact center system for assignment, the reinforcement learning model may consistently receive updated system states (e.g., the first state, the second state, etc.) after each iteration of the method 900 in order to assign the incoming contacts to available agents in a manner that minimizes slot gaps across all available agents based on the most up-to-date system state.

### Additional Considerations

The present techniques may involve the processing of input data and the generation of output data to some extent. This input data processing and output data generation may be implemented in hardware or software. For example, specific electronic components may be employed in a messaging feature server or similar or related circuitry for implementing the functions associated with agent capacity determination in accordance with the present disclosure as described above. Alternatively, one or more processors operating in accordance with instructions may implement the functions associated with agent capacity determination in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The description herein describes network elements, computers, and/or components that may include one or more modules. As used herein, the term “module” may be understood to refer to computing software, firmware, hardware, and/or various combinations thereof. Modules, however, are not to be interpreted as software, which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

The present disclosure is not to be limited in scope by the specific aspects described herein. Indeed, other various aspects of and modifications to the present disclosure, in addition to those described herein, will be apparent to those of ordinary skill in the art from the foregoing description and accompanying drawings. Thus, such other aspects and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes.

What is claimed is:

1. A method comprising:
obtaining, by a communications server, first information of a contact;
obtaining, by the communications server, active agent device information comprising at least a first agent identifier and a second agent identifier;
determining a first capacity of the first agent identifier based on a number of active interactions associated with the first agent identifier and a number of dormant interactions associated with the first agent identifier;
determining a second capacity of the second agent identifier based on a number of active interactions associated with the second agent identifier and a number of dormant interactions associated with the second agent identifier;
determining a conversation pattern of the contact based on the first information;
initiating a comparison of the first capacity and the second capacity based on the conversation pattern; and
assigning the contact to either of the first agent identifier and the second agent identifier based on the comparison, wherein assigning the contact comprises establishing a connection between a first device associated with the contact and a second device associated with the first agent identifier or the second agent identifier.

2. The method of claim 1, further comprising:
establishing a communication channel across the connection;
obtaining a first message at the second device transmitted by the first device; and
obtaining a second message at the first device transmitted by the second device.

3. The method of claim 2, further comprising:
after obtaining the first message at the second device transmitted by the first device, obtaining second information of the contact; and
determining an updated capacity of the agent identifier associated with the second device based on the second information of the contact.

4. The method of claim 2, further comprising:
after obtaining the first message at the second device transmitted by the first device, determining an expected wait time for obtaining a third message at the second device transmitted by the first device, wherein the expected wait time is based on the first message; and
determining an updated capacity of the agent identifier associated with the second device based on the expected wait time.

5. The method of claim 1, wherein determining the conversation pattern of the contact comprises:
obtaining historical contact-agent interaction data; and
determining the conversation pattern of the contact based on the historical contact-agent interaction data.

6. The method of claim 5, wherein the historical contact-agent interaction data is associated with the contact.

7. The method of claim 5, wherein the historical contact-agent interaction data is based on information from at least one other contact, the at least one other contact being different from the contact.

8. The method of claim 1, wherein determining the conversation pattern further comprises:
determining an interaction handle time for the contact.

9. The method of claim 1, wherein determining the conversation pattern further comprises:
determining a response rate variability for the contact.

10. The method of claim 1, wherein determining the conversation pattern further comprises:
training a machine-learning model based on a training dataset comprising historical contact-agent interaction data, wherein the machine-learning model is configured to output a prediction of an expected capacity of an agent.

11. The method of claim 1, wherein determining the conversation pattern further comprises:
determining a response lag time measurement based on historical contact-agent interaction data associated with a contact type of the contact.

12. The method of claim 1, further comprising:
wherein the first information comprises at least one of a message text and contextual data associated with the message text.

13. The method of claim 1, wherein the contact is communicatively coupled to a contact center and the contact transmits one or more messages to a third device associated with a third agent identifier.

14. A method for allocating contacts to agents, comprising:
obtaining contact center environment data associated with a contact center system;
training a reinforcement learning model based on a training dataset comprising historical contact-agent interaction data associated with the contact center system, wherein the reinforcement learning model is configured to output a contact-agent pairing;
obtaining a first state of the contact center system, the first state comprising (i) a utilization value of each agent of a plurality of agents, and (ii) an indication of at least one available contact;
assigning, based on using the first state as input to the trained reinforcement learning model to output contact-agent pairings for the plurality of agents, the at least one available contact to a first agent of the plurality of agents; and
outputting a second state of the contact center system based on assigning the at least one available contact to the first agent.

15. The method of claim 14, wherein training the reinforcement learning model further comprises:
determining a time period associated with an average agent response time per single contact-interaction, and
wherein the training dataset further comprises the time period.

16. The method of claim 15, wherein the time period is one of: 15 seconds, 30 seconds, 45 seconds, and 1 minute.

17. The method of claim 14, wherein training the reinforcement learning model further comprises:
determining at least one positive reward based on at least one of: an agent utilization value and a length of agent utilization, and
wherein the training dataset further comprises the at least one positive reward.

18. The method of claim 17, wherein the at least one positive reward comprises (i) an allocation reward based on a number of utilized time slots for a respective agent, and (ii) a time difference between a first time value that a respective agent is available and a second time value that the respective agent handled a final interaction.

19. The method of claim 18, wherein the at least one positive reward comprises a total agent reward, comprising a sum of the allocation reward for each respective agent.

20. The method of claim 14, wherein training the reinforcement learning model further comprises:
determining at least one negative reward based on at least one of: an agent wait time and a contact wait time, and
wherein the training dataset further comprises the at least one negative reward.

21. The method of claim 14, further comprising:
determining a contact arrival event or an agent state change event, and
wherein obtaining the first state of the contact center system occurs after the determining the contact arrival event or the agent state change event.

22. The method of claim 14, wherein the contact center environment data comprises any of: (i) a number of active conversations associated with one or more agents of the plurality of agents at the contact center system, (ii) a number of dormant conversations associated with one or more agents of the plurality of agents at the contact center system, (iii) a pattern associated with one or more contacts of a plurality of contacts handled by the contact center system, and (iv) a message text associated with one or more contacts of a plurality of contacts handled by the contact center system.

23. A communications system comprising:
one or more processors; and
a non-transitory computer-readable medium coupled to the one or more processors and storing instructions thereon that, when executed by the one or more processors, cause the communications system to:
obtain first information of a contact,
obtain active agent device information comprising at least a first agent identifier and a second agent identifier,
determine a first capacity of the first agent identifier based on a number of active interactions associated with the first agent identifier and a number of dormant interactions associated with the first agent identifier,
determine a second capacity of the second agent identifier based on a number of active interactions associated with the second agent identifier and a number of dormant interactions associated with the second agent identifier,
determine a conversation pattern of the contact based on the first information, initiate a comparison of the first capacity and the second capacity based on the conversation pattern, and
assign the contact to either of the first agent identifier and the second agent identifier based on the comparison, wherein assigning the contact establishes a connection between a first device associated with the contact and a second device associated with the first agent identifier or the second agent identifier.

24. A tangible, non-transitory computer-readable medium storing instructions that, when executed by one or more processors of a computing device, cause the computing device to:
obtain first information of a contact;
obtain active agent device information comprising at least a first agent identifier and a second agent identifier;
determine a first capacity of the first agent identifier based on a number of active interactions associated with the first agent identifier and a number of dormant interactions associated with the first agent identifier;
determine a second capacity of the second agent identifier based on a number of active interactions associated with the second agent identifier and a number of dormant interactions associated with the second agent identifier;
determine a conversation pattern of the contact based on the first information;
compare the first capacity and the second capacity based on the conversation pattern; and
assign the contact to either of the first agent identifier and the second agent identifier based on the comparison, wherein assigning the contact establishes a connection between a first device associated with the contact and a second device associated with the first agent identifier or the second agent identifier.
